(19) United States
(12) Patent Application Publication
(10) Pub. No.: US 2025/0317230 A1
(43) Pub. Date: Oct. 9, 2025

(54) APPARATUS AND METHOD FOR CODING OF RADIO PROGRAMS AND MULTIMEDIA SERVICES IN TELEVISION BROADCASTS

(71) Applicant: Fraunhofer-Gesellschaft zur Förderung der angewandten Forschung e.V., Muenchen (DE)

(72) Inventors: Alexander ZINK, Erlangen (DE); Markus PROSCH, Erlangen (DE); Guido LEISKER, Erlangen (DE); Stefan MELTZER, Erlangen (DE); André HIRSCH, Erlangen (DE); Markus TAUBER, Erlangen (DE); Thimmaiah KUPPANDA GANAPATHY, Erlangen (DE); S. Merrill WEISS, Edison, NJ (US)

(73) Assignee: Fraunhofer-Gesellschaft zur Förderung der angewandten Forschung e.V., Muenchen (DE)

(21) Appl. No.: 19/243,751

(22) Filed: Jun. 20, 2025

Related U.S. Application Data
(63) Continuation of application No. PCT/EP2023/085765, filed on Dec. 14, 2023.

(30) Foreign Application Priority Data
Dec. 20, 2022 (WO) PCT/EP2022/087095

(51) Int. Cl. H04H 60/73; H04H 20/59; H04H 60/25; H04L 1/00

(52) U.S. Cl. CPC H04H 60/73; H04H 20/59; H04H 60/25; H04L 1/0041

(57) ABSTRACT

FIG. 1 illustrates an apparatus for decoding according to an embodiment. The apparatus comprises an interface for receiving a plurality of ATSC Link-layer Protocol packets each of which comprising a packet header and a packet payload encapsulating digital content. Moreover, the apparatus comprises a decoding unit. In a first embodiment, the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content. The decoding unit is configured to decode the packet payload of each one of at least one ATSC Link-layer Protocol packet of the one or more ATSC Link-layer Protocol packets to obtain the digital content of said one of the at least one ATSC Link-layer Protocol packet.

### CROSS-REFERENCES TO RELATED APPLICATIONS

This application is a continuation of copending International Application No. PCT/EP2023/085765, filed Dec. 14, 2023, which is incorporated herein by reference in its entirety, and additionally claims priority from International Application No. PCT/EP2022/087095, filed Dec. 20, 2022, which is also incorporated herein by reference in its entirety.

The present invention relates to coding of radio programs and multimedia services in television broadcasts, in particular to the integration of the Distribution and Communications Protocol into ATSC, and to a transport of xHE-AAC and Journaline for audio and multimedia services in ATSC.

### BACKGROUND OF THE INVENTION

The ATSC standards are a group of standards provided by the Advanced Television Systems Committee (ATSC) for digital television transmissions. Details on the Data Link Layer Protocol employed by ATSC can be found in the respective standard, [1]: A/330:2022-03, “Link-Layer Protocol”, published 31 Mar. 2022. ALP (ATSC Link-layer Protocol) supports the encapsulation of IP packets.

However, ATSC does not provide native support for transmitting radio programs.

To circumvent the problem that ATSC does not provide native support for transmitting radio programs, broadcasters could transmit an audio-only television program. However, such an approach would be inefficient. Moreover, the well-established audio codec xHE-AAC (extended High Efficiency Advanced Audio Coding)/USAC (Unified Speech and Audio Coding), specifically designed and optimized for digital radio broadcasts could not be employed using such an approach. Furthermore, multimedia applications such as Journaline could not be used by employing such an approach. Journaline, also referred to as “NewsService Journaline” is, e.g., described in [10].

Digital Radio Mondiale (DRM) is a globally deployed radio broadcasting standard. It delivers full-featured digital radio services in a highly efficiently coded manner, together with advanced text and other data services, to make best use of available channel resources. In parts of the world where DRM is in use, it is highly desirable for a broadcaster to be able to create and transmit identical Multiplex Distribution Interface (MDI) streams both on radio broadcasting spectrum and on television spectrum that will be able to reach mobile and handheld devices efficiently, ensuring a consistent digital radio experience for consumers.

DRM allows to transmit multimedia data with particularly low data rates by employing the technologies xHE-AAC (extended High Efficiency Advanced Audio Coding)/USAC (Unified Speech and Audio Coding) and Journaline.

A particular technology employed by DRM is the Distribution and Communications Protocol (DCP) described in [3]: ETSI: TS 102 821, “Digital Radio Mondiale (DRM); Distribution and Communications Protocol (DCP),” V1.4.1 (2012-10), European Telecommunications Standards Institute, Valbonne-Sophia Antipolis France, October 2012.

However, the conventional technology does not provide concepts to transmit DRM via ATSC.

Radio broadcasters possess tools and devices, knowledge and experience for generating DRM data streams

As ATSC is attracting greater attention for potential adoption in more countries, it would be highly appreciated that ATSC can carry full-featured digital radio services in addition to the existing audio services for television.

### SUMMARY

According to an embodiment, an apparatus may have: an interface for receiving a plurality of ATSC Link-layer Protocol packets each of which includes a packet header and a packet payload encapsulating digital content, and a decoding unit, wherein the digital content being encapsulated within the packet payload of each of one or more ATSC Link-layer Protocol packets of the plurality of ATSC Link-layer Protocol packets includes digital radio content, and/or a Distribution and Communications Protocol packet or a portion thereof, and/or Unified Speech and Audio Coding content or extended High Efficiency Advanced Audio Coding content, and/or Journaline content, and wherein the decoding unit is configured to decode the packet payload of each one of at least one ATSC Link-layer Protocol packet of the one or more ATSC Link-layer Protocol packets to obtain the digital content of said one of the at least one ATSC Link-layer Protocol packet.

According to another embodiment, an apparatus for decoding may have: an interface for receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet, wherein one or more further ATSC Link-layer Protocol packets of the plurality of ATSC Link-layer Protocol packets include one or more fragments of a Link Mapping Table for services, wherein the one or more fragments of the Link Mapping Table for services indicate the one or more services of the ATSC transmission, wherein the decoding unit is configured to identify the ATSC Link-layer Protocol packet which includes content of one of the one or more services by analyzing the one or more fragments of the Link Mapping Table for services.

According to another embodiment, an apparatus for decoding may have: an interface for receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet, wherein one or more still further ATSC Link-layer Protocol packets of the plurality of ATSC Link-layer Protocol packets include one or more fragments of a Link Mapping Table for Service Grouping, which indicate one or more groupings of a plurality of services of an ATSC transmission, wherein the apparatus includes an output interface for providing, depending on at least one of the one or more groupings, an output that depends on at least one of the plurality of services.

According to another embodiment, an apparatus for decoding may have: an interface for receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet, wherein one or more other ATSC Link-layer Protocol packets of the plurality of ATSC Link-layer Protocol packets include one or more table fragments of each of one or more tables, wherein each of the one or more table fragments includes metadata supporting a selection of a service, and/or includes information on a content of the payload of each of one or more of the plurality of ATSC Link-layer Protocol packets, and/or includes information on another one of the one or more table fragments, wherein each table fragment of the one or more table fragments of each table of one or more tables includes table management information which includes management information for said table fragment and/or for said table, wherein the table management information includes information on one or more management parameters.

Another embodiment relates to an apparatus for generating a plurality of ATSC Link-layer Protocol packets, the apparatus having: an interface for receiving input data, and a packet generator for generating the plurality of ATSC Link-layer Protocol packets depending on the input data, such that each of the plurality of ATSC Link-layer Protocol packets includes a packet header and a packet payload encapsulating digital content, wherein the packet generator is configured to generate one or more ATSC Link-layer Protocol packets of the plurality of ATSC Link-layer Protocol packets, such that the digital content being encapsulated within the packet payload of each of the one or more ATSC Link-layer Protocol packets includes digital radio content, and/or a Distribution and Communications Protocol packet or a portion thereof, and/or Unified Speech and Audio Coding content or extended High Efficiency Advanced Audio Coding content, and/or Journaline content.

Another embodiment relates to an apparatus for generating a plurality of ATSC Link-layer Protocol packets, the apparatus having: an interface for receiving input data, and a packet generator for generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the packet generator is configured to generate the plurality of ATSC Link-layer Protocol packets, such that one or more further ATSC Link-layer Protocol packets of the plurality of ATSC Link-layer Protocol packets include one or more fragments of a Link Mapping Table for services, wherein the one or more fragments of the Link Mapping Table for services indicate the one or more services of the ATSC transmission.

Another embodiment relates to an apparatus for generating a plurality of ATSC Link-layer Protocol packets, the apparatus having: an interface for receiving input data, and a packet generator for generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the packet generator is configured to generate the plurality of ATSC Link-layer Protocol packets, such that one or more still further ATSC Link-layer Protocol packets of the plurality of ATSC Link-layer Protocol packets include one or more fragments of a Link Mapping Table for Service Grouping, which indicate one or more groupings of a plurality of services of an ATSC transmission.

Another embodiment relates to an apparatus for generating a plurality of ATSC Link-layer Protocol packets, the apparatus having: an interface for receiving input data, and a packet generator for generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the packet generator is configured to generate the plurality of ATSC Link-layer Protocol packets, such that one or more other ATSC Link-layer Protocol packets of the plurality of ATSC Link-layer Protocol packets include one or more table fragments of each of one or more tables, wherein each of the one or more table fragments includes metadata supporting a selection of a service, and/or includes information on a content of the payload of each of one or more of the plurality of ATSC Link-layer Protocol packets, and/or includes information on another one of the one or more table fragments, wherein each table fragment of the one or more table fragments of each table of one or more tables includes table management information which includes management information for said table fragment and/or for said table, wherein the table management information includes information on one or more management parameters.

Another embodiment relates to a data stream having a plurality of ATSC Link-layer Protocol packets, wherein each of the plurality of ATSC Link-layer Protocol packets includes a packet header and a packet payload encapsulating digital content, wherein the digital content being encapsulated within the packet payload of each of one or more ATSC Link-layer Protocol packets of the plurality of ATSC Link-layer Protocol packets includes digital radio content, and/or a Distribution and Communications Protocol packet or a portion thereof, and/or Unified Speech and Audio Coding content or extended High Efficiency Advanced Audio Coding content, and/or Journaline content.

Another embodiment relates to a data stream having a plurality of ATSC Link-layer Protocol packets, wherein each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the data stream includes one or more ATSC Link-layer Protocol packets of the plurality of ATSC Link-layer Protocol packets, which include one or more fragments of a Link Mapping Table for services, wherein the one or more fragments of the Link Mapping Table for services indicate the one or more services of the ATSC transmission.

Another embodiment relates to a data stream having a plurality of ATSC Link-layer Protocol packets, wherein each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the data stream includes one or more still further ATSC Link-layer Protocol packets of the plurality of ATSC Link-layer Protocol packets, which include one or more fragments of a Link Mapping Table for Service Grouping, which indicate one or more groupings of a plurality of services of an ATSC transmission.

Another embodiment relates to a data stream having a plurality of ATSC Link-layer Protocol packets, wherein each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein one or more other ATSC Link-layer Protocol packets of the plurality of ATSC Link-layer Protocol packets include one or more table fragments of each of one or more tables, wherein each of the one or more table fragments includes metadata supporting a selection of a service, and/or includes information on a content of the payload of each of one or more of the plurality of ATSC Link-layer Protocol packets, and/or includes information on another one of the one or more table fragments, wherein each table fragment of the one or more table fragments of each table of one or more tables includes table management information which includes management information for said table fragment and/or for said table, wherein the table management information includes information on one or more management parameters.

According to another embodiment, a method for decoding may have the steps of: receiving a plurality of ATSC Link-layer Protocol packets each of which includes a packet header and a packet payload encapsulating digital content, wherein the digital content being encapsulated within the packet payload of each of one or more ATSC Link-layer Protocol packets of the plurality of ATSC Link-layer Protocol packets includes digital radio content, and/or a Distribution and Communications Protocol packet or a portion thereof, and/or Unified Speech and Audio Coding content or extended High Efficiency Advanced Audio Coding content, and/or Journaline content, and decoding the packet payload of each one of at least one ATSC Link-layer Protocol packet of the one or more ATSC Link-layer Protocol packets to obtain the digital content of said one of the at least one ATSC Link-layer Protocol packet.

According to another embodiment, a method for decoding may have the steps of: receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and decoding the packet payload of each one of at least one ATSC Link-layer Protocol packet of the plurality of ATSC Link-layer Protocol packets to obtain the digital content of said one of the at least one ATSC Link-layer Protocol packet, wherein one or more further ATSC Link-layer Protocol packets of the plurality of ATSC Link-layer Protocol packets include one or more fragments of a Link Mapping Table for services, wherein the one or more fragments of the Link Mapping Table for services indicate the one or more services of the ATSC transmission, wherein the method includes identifying the ATSC Link-layer Protocol packet which includes content of one of the one or more services by analyzing the one or more fragments of the Link Mapping Table for services.

According to another embodiment, a method for decoding may have the steps of: receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and decoding the packet payload of each one of at least one ATSC Link-layer Protocol packet of the plurality of ATSC Link-layer Protocol packets to obtain the digital content of said one of the at least one ATSC Link-layer Protocol packet, wherein one or more still further ATSC Link-layer Protocol packets of the plurality of ATSC Link-layer Protocol packets include one or more fragments of a Link Mapping Table for Service Grouping, which indicate one or more groupings of a plurality of services of an ATSC transmission, wherein the method includes providing, depending on at least one of the one or more groupings, an output that depends on at least one of the plurality of services.

According to another embodiment, a method for decoding may have the steps of: receiving a plurality of ATSC Link-layer Protocol packets each of which includes a packet header and a packet payload encapsulating digital content, wherein one or more of the plurality of ATSC Link-layer Protocol packets includes content of one or more services of an ATSC transmission, and decoding the packet payload of each one of at least one ATSC Link-layer Protocol packet of the plurality of ATSC Link-layer Protocol packets to obtain the digital content of said one of the at least one ATSC Link-layer Protocol packet, wherein one or more other ATSC Link-layer Protocol packets of the plurality of ATSC Link-layer Protocol packets include one or more table fragments of each of one or more tables, wherein each of the one or more table fragments includes metadata supporting a selection of a service, and/or includes information on a content of the payload of each of one or more of the plurality of ATSC Link-layer Protocol packets, and/or includes information on another one of the one or more table fragments, wherein each table fragment of the one or more table fragments of each table of one or more tables includes table management information which includes management information for said table fragment and/or for said table, wherein the table management information includes information on one or more management parameters.

According to another embodiment, a method for generating a plurality of ATSC Link-layer Protocol packets may have the steps of: receiving input data, and generating the plurality of ATSC Link-layer Protocol packets depending on the input data, such that each of the plurality of ATSC Link-layer Protocol packets includes a packet header and a packet payload encapsulating digital content, wherein generating one or more ATSC Link-layer Protocol packets of the plurality of ATSC Link-layer Protocol packets is conducted, such that the digital content being encapsulated within the packet payload of each of the one or more ATSC Link-layer Protocol packets includes digital radio content, and/or a Distribution and Communications Protocol packet or a portion thereof, and/or Unified Speech and Audio Coding content or extended High Efficiency Advanced Audio Coding content, and/or Journaline content.

According to another embodiment, a method for generating a plurality of ATSC Link-layer Protocol packets may have the steps of: receiving input data, and generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein the method includes generating the plurality of ATSC Link-layer Protocol packets, such that one or more further ATSC Link-layer Protocol packets of the plurality of ATSC Link-layer Protocol packets include one or more fragments of a Link Mapping Table for services, wherein the one or more fragments of the Link Mapping Table for services indicate the one or more services of the ATSC transmission.

According to another embodiment, a method for generating a plurality of ATSC Link-layer Protocol packets, may have the steps of: receiving input data, and generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein generating the plurality of ATSC Link-layer Protocol packets is conducted, such that one or more still further ATSC Link-layer Protocol packets of the plurality of ATSC Link-layer Protocol packets include one or more fragments of a Link Mapping Table for Service Grouping, which indicate one or more groupings of a plurality of services of an ATSC transmission.

According to another embodiment, a method for generating a plurality of ATSC Link-layer Protocol packets may have the steps of: receiving input data, and generating the plurality of ATSC Link-layer Protocol packets depending on the input data, such that each of the plurality of ATSC Link-layer Protocol packets includes a packet header and a packet payload encapsulating digital content, wherein one or more of the plurality of ATSC Link-layer Protocol packets includes content of one or more services of an ATSC transmission, wherein generating the plurality of ATSC Link-layer Protocol packets is conducted, such that one or more other ATSC Link-layer Protocol packets of the plurality of ATSC Link-layer Protocol packets include one or more table fragments of each of one or more tables, wherein each of the one or more table fragments includes metadata supporting a selection of a service, and/or includes information on a content of the payload of each of one or more of the plurality of ATSC Link-layer Protocol packets, and/or includes information on another one of the one or more table fragments, wherein each table fragment of the one or more table fragments of each table of one or more tables includes table management information which includes management information for said table fragment and/or for said table, wherein the table management information includes information on one or more management parameters.

Another embodiment may have a non-transitory digital storage medium having a computer program stored thereon to perform any of the inventive methods when said computer program is run by a computer.

An apparatus for decoding according to an embodiment is provided. The apparatus comprises an interface for receiving a plurality of ATSC Link-layer Protocol packets each of which includes a packet header and a packet payload encapsulating digital content. Moreover, the apparatus comprises a decoding unit. The digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content. The decoding unit is configured to decode the packet payload of each one of at least one ATSC Link-layer Protocol packet of the one or more ATSC Link-layer Protocol packets to obtain the digital content of said one of the at least one ATSC Link-layer Protocol packet.

Moreover, an apparatus for decoding according to another embodiment is provided. The apparatus comprises an interface for receiving a plurality of ATSC Link-layer Protocol packets each of which includes a packet header and a packet payload encapsulating digital content, wherein one or more of the plurality of ATSC Link-layer Protocol packets comprises content of one or more services of an ATSC transmission. Moreover, the apparatus comprises a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet. One or more further ATSC Link-layer Protocol packets of the plurality of ATSC Link-layer Protocol packets comprise one or more fragments of a Link Mapping Table for services. The one or more fragments of the Link Mapping Table for services indicate the one or more services of the ATSC transmission. The decoding unit is configured to identify the ATSC Link-layer Protocol packet which comprises content of one of the one or more services by analyzing the one or more fragments of the Link Mapping Table for services.

Furthermore, an apparatus for decoding according to a further embodiment is provided. The apparatus comprises an interface for receiving a plurality of ATSC Link-layer Protocol packets each of which includes a packet header and a packet payload encapsulating digital content, wherein one or more of the plurality of ATSC Link-layer Protocol packets comprises content of one or more services of an ATSC transmission. Moreover, the apparatus comprises a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet. One or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. The apparatus comprises an output interface for providing, depending on at least one of the one or more groupings, an output that depends on at least one of the plurality of services.

Moreover, an apparatus for decoding according to another embodiment is provided. The apparatus comprises an interface for receiving a plurality of ATSC Link-layer Protocol packets each of which includes a packet header and a packet payload encapsulating digital content, wherein one or more of the plurality of ATSC Link-layer Protocol packets comprises content of one or more services of an ATSC transmission. Moreover, the apparatus comprises a decoding unit, wherein the decoding unit is configured to decode the packet payload of each one of at least one ATSC Link-layer Protocol packet of the plurality of ATSC Link-layer Protocol packets to obtain the digital content of said one of the at least one ATSC Link-layer Protocol packet. One or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments. Each table fragment of the one or more table fragments of each table of one or more tables comprises table management information which comprises management information for said table fragment and/or for said table, wherein the table management information comprises information on one or more management parameters.

Furthermore, an apparatus for generating a plurality of ATSC Link-layer Protocol packets according to an embodiment is provided. The apparatus comprises an interface for receiving input data. Moreover, the apparatus comprises a packet generator for generating the plurality of ATSC Link-layer Protocol packets depending on the input data, such that each of the plurality of ATSC Link-layer Protocol packets comprises a packet header and a packet payload encapsulating digital content. The packet generator is configured to generate one or more ATSC Link-layer Protocol packets of the plurality of ATSC Link-layer Protocol packets, such that the digital content being encapsulated within the packet payload of each of the one or more ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

Moreover, an apparatus for generating a plurality of ATSC Link-layer Protocol packets according to a further embodiment is provided. The apparatus comprises an interface for receiving input data. Moreover, the apparatus comprises a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. The packet generator is configured to generate the plurality of ATSC Link-layer Protocol packets, such that one or more further ATSC Link-layer Protocol packets of the plurality of ATSC Link-layer Protocol packets comprise one or more fragments of a Link Mapping Table for services, wherein the one or more fragments of the Link Mapping Table for services indicate the one or more services of the ATSC transmission.

Furthermore, an apparatus for generating a plurality of ATSC Link-layer Protocol packets according to another embodiment is provided. The apparatus comprises an interface for receiving input data. Moreover, the apparatus of FIG. 2 comprises a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. The packet generator is configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

Moreover, an apparatus for generating a plurality of ATSC Link-layer Protocol packets according to a further embodiment is provided. The apparatus comprises an interface for receiving input data. Moreover, the apparatus comprises a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. The packet generator is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments. Each table fragment of the one or more table fragments of each table of one or more tables comprises table management information which comprises management information for said table fragment and/or for said table, wherein the table management information comprises information on one or more management parameters.

Furthermore, a data stream comprising a plurality of ATSC Link-layer Protocol packets according to an embodiment is provided. Each of the plurality of ATSC Link-layer Protocol packets comprises a packet header and a packet payload encapsulating digital content. The digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

Moreover, a data stream comprising a plurality of ATSC Link-layer Protocol packets according to another embodiment is provided. Each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. The data stream comprises one or more ATSC Link-layer Protocol packets of the plurality of ATSC Link-layer Protocol packets, which comprise one or more fragments of a Link Mapping Table for services. The one or more fragments of the Link Mapping Table for services indicate the one or more services of the ATSC transmission.

Furthermore, a data stream comprising a plurality of ATSC Link-layer Protocol packets according to a further embodiment is provided. Each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. The data stream comprises one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission.

Moreover, a data stream comprising a plurality of ATSC Link-layer Protocol packets according to another embodiment is provided. Each of the plurality of ATSC Link-layer Protocol packets comprises a packet header and a packet payload encapsulating digital content, wherein one or more of the plurality of ATSC Link-layer Protocol packets comprises content of one or more services of an ATSC transmission. One or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments. Each table fragment of the one or more table fragments of each table of one or more tables comprises table management information which comprises management information for said table fragment and/or for said table, wherein the table management information comprises information on one or more management parameters.

Furthermore, a method for decoding according to an embodiment is provided. The method comprises:
Receiving a plurality of ATSC Link-layer Protocol packets each of which comprising a packet header and a packet payload encapsulating digital content, wherein the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content. And:
Decoding the packet payload of each one of at least one ATSC Link-layer Protocol packet of the one or more ATSC Link-layer Protocol packets to obtain the digital content of said one of the at least one ATSC Link-layer Protocol packet.

Moreover, a method for decoding according to a further embodiment is provided. The method comprises:
Receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission. And:
Decoding the packet payload of each one of at least one ATSC Link-layer Protocol packet of the plurality of ATSC Link-layer Protocol packets to obtain the digital content of said one of the at least one ATSC Link-layer Protocol packet.

One or more further ATSC Link-layer Protocol packets of the plurality of ATSC Link-layer Protocol packets comprise one or more fragments of a Link Mapping Table for services. The one or more fragments of the Link Mapping Table for services indicate the one or more services of the ATSC transmission. The method comprises identifying the ATSC Link-layer Protocol packet which comprises content of one of the one or more services by analyzing the one or more fragments of the Link Mapping Table for services.

Furthermore, a method for decoding according to another embodiment is provided. The method comprises:
Receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission. And:
Decoding the packet payload of each one of at least one ATSC Link-layer Protocol packet of the plurality of ATSC Link-layer Protocol packets to obtain the digital content of said one of the at least one ATSC Link-layer Protocol packet.

One or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. The method comprises providing, depending on at least one of the one or more groupings, an output that depends on at least one of the plurality of services.

Moreover, a method for decoding according to a further embodiment is provided. The method comprises:
Receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission. And:
Decoding the packet payload of each one of at least one ATSC Link-layer Protocol packet of the plurality of ATSC Link-layer Protocol packets to obtain the digital content of said one of the at least one ATSC Link-layer Protocol packet.

One or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments. Each table fragment of the one or more table fragments of each table of one or more tables comprises table management information which comprises management information for said table fragment and/or for said table, wherein the table management information comprises information on one or more management parameters.

Furthermore, a method for generating a plurality of ATSC Link-layer Protocol packets according to an embodiment is provided. The method comprises:
Receiving input data. And:
   Generating the plurality of ATSC Link-layer Protocol packets depending on the input data, such that each of the plurality of ATSC Link-layer Protocol packets comprises a packet header and a packet payload encapsulating digital content.

Generating one or more ATSC Link-layer Protocol packets of the plurality of ATSC Link-layer Protocol packets is conducted, such that the digital content being encapsulated within the packet payload of each of the one or more ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

Moreover, a method for generating a plurality of ATSC Link-layer Protocol packets according to another embodiment is provided. The method comprises:
Receiving input data. And:
   Generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The method comprises generating the plurality of ATSC Link-layer Protocol packets, such that one or more further ATSC Link-layer Protocol packets of the plurality of ATSC Link-layer Protocol packets comprise one or more fragments of a Link Mapping Table for services, wherein the one or more fragments of the Link Mapping Table for services indicate the one or more services of the ATSC transmission.

Furthermore, a method for generating a plurality of ATSC Link-layer Protocol packets according to an embodiment is provided. The method comprises:
Receiving input data. And:
   Generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

Generating the plurality of ATSC Link-layer Protocol packets is conducted, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

Moreover, a method for generating a plurality of ATSC Link-layer Protocol packets according to another embodiment is provided. The method comprises:
Receiving input data. And:
   Generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

Generating the plurality of ATSC Link-layer Protocol packets is conducted, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,

Each table fragment of the one or more table fragments of each table of one or more tables comprises table management information which comprises management information for said table fragment and/or for said table, wherein the table management information comprises information on one or more management parameters.

Furthermore, a computer program for implementing the one of the above-described methods when being executed on a computer or signal processor according to an embodiment is provided.

Embodiments realize a low-level packet transport in ATSC.

In some embodiments, DCP Packet Encapsulation in ATSC is realized.

According to some embodiments, an ALP Packet structure for DCP encapsulation is provided.

Some embodiments support specific ‘Digital Radio’ applications.

For example, according to some embodiments, a DRM Integration in ATSC is realized, e.g., using DCP Encapsulation.

By integrating DRM into ATSC, in embodiments, the xHE-AAC/USAC audio codec and Journaline text application become available in ATSC.

In particular, in some embodiments, an integration of Digital Radio Mondiale (DRM) data streams into ATSC signals, system configurations, bit bandwidth allocations to services, signaling optimizations may, e.g., be realized.

According to an embodiment, a Link Mapping Table for DRM Radio is provided.

In embodiments, LMT-R Fragments (for example, spreading across multiple PLPs (physical layer pipes), versioning, fragment management, etc.) are provided.

According to an embodiment, ALP Packet Additional Header Values for LMT-R are provided.

In an embodiment, an access to DRM service metadata in general for service selection, and a link to a physical DCP stream carrying the respective radio service are provided.

Optionally, a Link Mapping Table for DRM-Radio Service Grouping Selection is provided. For example, a generic, ATSC transmission-wide definition of categories such as language, country of origin, program type, target audience, broadacster network, etc. may, e.g., be provided. Then, an assignment of every DRM service to none, to one or more values in any or every category may, e.g., be conducted. A technical implementation may, for example, be conducted using LMT-R-SG fragments, spreading across PLP, versioning, etc.

According to some embodiments, an ATSC standard A/330 (see [1]) revision for signaling & carriage of DRM DCP packets is provided.

In embodiments, an addition to A/330 enabling carriage of an additional type of data packets together with definition of the signaling that makes use of the new data type practical is provided.

According to embodiments, DRM DCP packets are added to the types of data formats that can be carried directly in ATSC Link-layer Protocol (ALP) packet streams and provide several specialized Link Mapping Tables (LMTs) to support a receiver locating specific DRM services carried in Multiplex Distribution Interface (MDI) streams within the DCP packets. The LMTs according to embodiments provide sufficient information and supporting elements to enable selecting specific DRM services within an ATSC 3.0 transmission efficiently.

In embodiments, the structural provisions of A/330 are extended through use of certain reserved addresses that are supposed to be ignored by devices that are unaware of any assigned uses for them. Thus, they use the extensibility features built into ATSC 3.0 just for such purposes. Existing ATSC TV and data services implemented according to the relevant standards will not be affected by this addition.

Embodiments realize to transmit DRM and thus, also xHE-AAC and Journaline, via ATSC. By signaling the services in ATSC, the receivers can access the programs and services and can replay then.

In embodiments, a very efficient signaling of services is provided.

According to embodiment, a transmission of radio programs is realized in a way that users can really find and distinguish them from television broadcast programs.

Embodiments provide that mobile devices can switch between different communication paths (depending on their availability), wherein service layer decoding may, e.g., be employed for all communication paths. The terminals may, e.g., receive the same digital radio standard (DRM) also via ATSC (e.g., if the particular broadcast program is not directly available via DRM).

Embodiments provide devices or software on a transmission side, which provide DRM to ATSC or which multiplex and/or transmit DRM within ATSC.

Embodiments provide devices and software on a receiver side for receiving, decoding and replaying ATSC, wherein DCP is transmitted via ATSC.

### BRIEF DESCRIPTION OF THE DRAWINGS

Embodiments of the present invention will be detailed subsequently referring to the appended drawings, in which:

FIG. 1 illustrates an apparatus for decoding according to an embodiment.

FIG. 2 illustrates an apparatus for generating a plurality of ATSC Link-layer Protocol packets according to an embodiment.

FIG. 3 illustrates a data stream comprising a plurality of ATSC Link-layer Protocol packets according to an embodiment.

FIG. 4 illustrates components of the Service Group mechanism, in particular, Categories and Properties.

FIG. 5 illustrates a Service Grouping mechanism, in particular, an example of service grouping through a multi-screen sequence.

FIG. 6 illustrates a Service Grouping mechanism, in particular, an example of single-screen service grouping through in-between Property headlines.

FIG. 7 illustrates a Service Grouping mechanism, in particular, an example of service filtering.

### DETAILED DESCRIPTION OF THE INVENTION

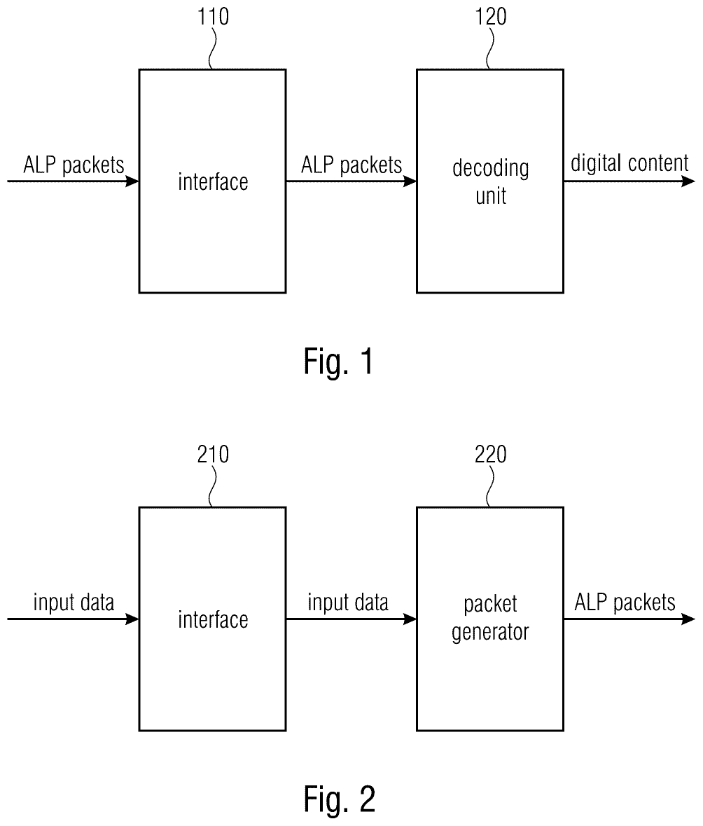

FIG. 1 illustrates an apparatus for decoding according to an embodiment.

The apparatus comprises an interface 110 for receiving a plurality of ATSC Link-layer Protocol packets each of which comprising a packet header and a packet payload encapsulating digital content.

Moreover, the apparatus comprises a decoding unit 120.

In a first embodiment, the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

The decoding unit 120 is configured to decode the packet payload of each one of at least one ATSC Link-layer Protocol packet of the one or more ATSC Link-layer Protocol packets to obtain the digital content of said one of the at least one ATSC Link-layer Protocol packet.

According to an embodiment, the digital content being encapsulated within the packet payload of an ATSC Link-layer Protocol packet of the one or more ATSC Link-layer Protocol packets may, e.g., comprise digital radio content. The decoding unit 120 may, e.g., be configured to decode the packet payload of said ATSC Link-layer Protocol packet to obtain the digital radio content being encapsulated within the packet payload of said ATSC Link-layer Protocol packet.

In an embodiment, the digital content being encapsulated within the packet payload of an ATSC Link-layer Protocol packet of the one or more ATSC Link-layer Protocol packets may, e.g., comprise a Distribution and Communications Protocol packet or a portion thereof. The decoding unit 120 may, e.g., be configured to decode the packet payload of said ATSC Link-layer Protocol packet to obtain the Distribution and Communications Protocol packet or the portion thereof being encapsulated within the packet payload of said ATSC Link-layer Protocol packet.

According to an embodiment, the Distribution and Communications Protocol packet or the portion thereof being encapsulated within the packet payload of said ATSC Link-layer Protocol packet may, e.g., comprise digital radio content. The decoding unit 120 may, e.g., be configured to decode the packet payload of said ATSC Link-layer Protocol packet to obtain the digital radio content being comprised by the Distribution and Communications Protocol packet or the portion thereof being encapsulated within the packet payload of said ATSC Link-layer Protocol packet.

In an embodiment, the digital radio content may, e.g., comprise Digital Radio Mondial content.

According to an embodiment, the digital content being encapsulated within the packet payload of an ATSC Link-layer Protocol packet of the one or more ATSC Link-layer Protocol packets may, e.g., comprise Unified Speech and Audio Coding content or extended High Efficiency Advanced Audio Coding content. The decoding unit 120 may, e.g., be configured to decode the packet payload of said ATSC Link-layer Protocol packet to obtain the Unified Speech and Audio Coding content or the extended High Efficiency Advanced Audio Coding content being encapsulated within the packet payload of said ATSC Link-layer Protocol packet.

In an embodiment, the digital content being encapsulated within the packet payload of an ATSC Link-layer Protocol packet of the one or more ATSC Link-layer Protocol packets may, e.g., comprise Journaline content. The decoding unit 120 may, e.g., be configured to decode the packet payload of said ATSC Link-layer Protocol packet to obtain the Journaline content being encapsulated within the packet payload of said ATSC Link-layer Protocol packet.

According to an embodiment, the apparatus further may, e.g., comprise a renderer for providing an output, being one or more audio output signals, or being a visual output, or being a data output, depending on the digital content being encapsulated within said ATSC Link-layer Protocol packet.

In an embodiment, the renderer may, e.g., be configured to provide the output using the Journaline content.

According to an embodiment, one or more further ATSC Link-layer Protocol packets of the plurality of ATSC Link-layer Protocol packets comprise one or more fragments of a Link Mapping Table for services. The one or more fragments of the Link Mapping Table for services indicate one or more services of an ATSC transmission. The decoding unit 120 may, e.g., be configured to identify the ATSC Link-layer Protocol packet which may, e.g., comprise content of one of the one or more services by analyzing the one or more fragments of the Link Mapping Table for services.

In a first variant of the first embodiment of FIG. 1, the apparatus of FIG. 1 comprises an interface 110 for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission.

Moreover, the apparatus comprises a decoding unit 120, wherein the decoding unit 120 is configured to decode the packet payload of each one of at least one ATSC Link-layer Protocol packet of the plurality of ATSC Link-layer Protocol packets to obtain the digital content of said one of the at least one ATSC Link-layer Protocol packet.

One or more further ATSC Link-layer Protocol packets of the plurality of ATSC Link-layer Protocol packets comprise one or more fragments of a Link Mapping Table for services.

The one or more fragments of the Link Mapping Table for services indicate the one or more services of the ATSC transmission.

The decoding unit 120 is configured to identify the ATSC Link-layer Protocol packet which comprises content of one of the one or more services by analyzing the one or more fragments of the Link Mapping Table for services.

According to an embodiment, the one or more fragments of the Link Mapping Table for services are one or more fragments of a Link Mapping Table for radio services. The one or more fragments of the Link Mapping Table for radio services indicate one or more radio services of the ATSC transmission. The decoding unit 120 may, e.g., be configured to identify the ATSC Link-layer Protocol packet which may, e.g., comprise content of one of the one or more radio services by analyzing the one or more fragments of the Link Mapping Table for radio services.

In an embodiment, the one or more fragments of the Link Mapping Table for radio services comprise metadata for the one or more radio services of the ATSC transmission.

According to an embodiment, at least some of the plurality of ATSC Link-layer Protocol packets encapsulate a plurality of Distribution and Communications Protocol packets comprising the one or more radio services of the ATSC transmission.

In an embodiment, the metadata for the one or more radio services may, e.g., comprise information on a service label, and/or information on a multiplex label, and/or information on a language, and/or information on a program type, and/or information on a region, and/or information on a country of origin, and/or audio configuration information, and/or a data application identifier.

According to an embodiment, the one or more fragments of the Link Mapping Table for radio services are one or more fragments of the Link Mapping Table for Digital Radio Mondiale-Radio. The one or more fragments of the Link Mapping Table for Digital Radio Mondiale-Radio indicate one or more Digital Radio Mondiale radio services of the ATSC transmission. The decoding unit 120 may, e.g., be configured to identify the ATSC Link-layer Protocol packet which may, e.g., comprise content of one of the one or more Digital Radio Mondiale radio services by analyzing the one or more fragments of the Link Mapping Table for Digital Radio Mondiale-Radio.

In an embodiment, the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams. The decoding unit 120 may, e.g., be configured to identify the ATSC Link-layer Protocol packet which may, e.g., comprise the Digital Radio Mondiale content depending on the association.

According to an embodiment, the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

In an embodiment, the metadata for one of the one or more Digital Radio Mondiale radio services corresponds to metadata being comprised by one of the one or more Digital Radio Mondiale Multiplex Distribution Interface streams, which are associated with the one or more Digital Radio Mondiale radio services.

According to an embodiment, the one or more fragments of the Link Mapping Table for radio services comprise emergency warning information indicating whether or not an emergency warning is indicated by at least one of one or more the Digital Radio Mondiale Multiplex Distribution Interface streams, which are associated with the one or more Digital Radio Mondiale radio services. The decoding unit 120 may, e.g., be configured to analyse the emergency warning information for determining, whether or not an emergency warning is indicated.

In an embodiment, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets may, e.g., comprise a same sub-stream identifier being associated with the Digital Radio Mondiale Multiplex Distribution Interface stream. The decoding unit 120 may, e.g., be configured to decode the Digital Radio Mondiale Multiplex Distribution Interface stream, by analysing the sub-stream identifier of the packet header of the two ATSC Link-layer Protocol packets and by decoding the packet payload of the two ATSC Link-layer Protocol packets.

According to an embodiment, the one or more fragments of the Link Mapping Table for radio services are one or more fragments of the Link Mapping Table for Digital Audio Broadcasting. The one or more fragments of the Link Mapping Table for Digital Audio Broadcasting indicate one or more Digital Audio Broadcasting services of the ATSC transmission. The decoding unit 120 may, e.g., be configured to identify the ATSC Link-layer Protocol packet which may, e.g., comprise content of one of the one or more Digital Audio Broadcasting services by analyzing the one or more fragments of the Link Mapping Table for Digital Audio Broadcasting.

In an embodiment, the one or more fragments of the Link Mapping Table for Digital Audio Broadcasting indicate an association of at least one of the one or more Digital Audio Broadcasting services with one or more EDI (Encapsulation of DAB Interfaces) streams. The decoding unit 120 may, e.g., be configured to identify the ATSC Link-layer Protocol packet which may, e.g., comprise the Digital Audio Broadcasting content depending on the association.

According to an embodiment, the one or more further ATSC Link-layer Protocol packets are two or more further ATSC Link-layer Protocol packets, wherein the one or more fragments are two or more fragments, wherein the one or more services are a plurality of services. The two or more further ATSC Link-layer Protocol packets comprise the two or more fragments of the Link Mapping Table for services. Moreover, the two or more fragments of the Link Mapping Table for services indicate the plurality of services of the ATSC transmission. The decoding unit 120 may, e.g., be configured to identify the ATSC Link-layer Protocol packet which may, e.g., comprise the content of one of the one or more services by analyzing the two or more fragments of the Link Mapping Table for services.

In an embodiment, one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission. The apparatus may, e.g., comprise an output interface for providing, depending on at least one of the one or more groupings, an output that depends on at least one of the plurality of services.

In a second variant of the first embodiment of FIG. 1, the apparatus of FIG. 1 comprises an interface 110 for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission.

Moreover, the apparatus comprises a decoding unit 120, wherein the decoding unit 120 is configured to decode the packet payload of each one of at least one ATSC Link-layer Protocol packet of the plurality of ATSC Link-layer Protocol packets to obtain the digital content of said one of the at least one ATSC Link-layer Protocol packet.

One or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

The apparatus comprises an output interface for providing, depending on at least one of the one or more groupings, an output that depends on at least one of the plurality of services.

According to an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission. The output interface may, e.g., be configured to provide, depending on at least one of the one or more groupings, an output that depends on at least one of the plurality of radio services.

In an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission. The output interface may, e.g., be configured to provide, depending on at least one of the one or more groupings, an output that depends on at least one of the plurality of Digital Radio Mondiale radio services.

According to an embodiment, the one or more fragments of the Link Mapping Table for Service Grouping are one or more fragments of a Link Mapping Table for Digital Audio Broadcasting Service Grouping. The one or more fragments of the Link Mapping Table for Digital Audio Broadcasting Service Grouping indicate one or more groupings of a plurality of Digital Audio Broadcasting services of the ATSC transmission. The output interface may, e.g., be configured to provide, depending on at least one of the one or more groupings, an output that depends on at least one of the plurality of Digital Audio Broadcasting Digital Audio Broadcasting services.

In an embodiment, the one or more still further ATSC Link-layer Protocol packets are two or more still further ATSC Link-layer Protocol packets, wherein the one or more fragments of the Link Mapping Table for Service Grouping are two or more fragments. The two or more still further ATSC Link-layer Protocol packets comprise the two or more fragments of the Link Mapping Table for Service Grouping.

According to an embodiment, the apparatus may, e.g., be configured to employ the Link Mapping Table for Service Grouping to allow a user to select a service from the plurality of services.

In an embodiment, the apparatus may, e.g., be configured to employ the Link Mapping Table for Service Grouping to present a user a filtered subset of the plurality of services depending on one or more filter criteria.

According to an embodiment, the output interface may, e.g., be configured to output information on at least two of the plurality of services depending on at least one of the one or more groupings. The apparatus may, e.g., comprise a user interface or another mechanism for allowing a user to select a service from the information on the at least two of the plurality of services.

In an embodiment, the one or more fragments of the Link Mapping Table for Service Grouping associate two or more of the plurality of services with at least one of two or more categories, and/or with at least one of two or more properties.

According to an embodiment, if a user has selected, using the user interface or the other mechanism, at least two categories from the two or more categories, the output interface may, e.g., be configured to present only those of the plurality of services to the user which are associated with all of the at least two categories which the user has selected.

In an embodiment, if a user has selected, using the user interface or the other mechanism, at least two properties from the two or more properties, the output interface may, e.g., be configured to present those of the plurality of services to the user which are associated with at least one of the at least two properties which the user has selected.

According to an embodiment, the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

In an embodiment, the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

According to an embodiment, one or more other ATSC Link-layer Protocol packets of the plurality of ATSC Link-layer Protocol packets comprise one or more table fragments of each of one or more tables, wherein each of the one or more table fragments may, e.g., comprise metadata supporting a selection of a service, and/or may, e.g., comprise information on a content of the payload of each of one or more of the plurality of ATSC Link-layer Protocol packets, and/or may, e.g., comprise information on another one of the one or more table fragments. Each table fragment of the one or more table fragments of each table of one or more tables may, e.g., comprise table management information which may, e.g., comprise management information for said table fragment and/or for said table, wherein the table management information may, e.g., comprise information on one or more management parameters.

In a third variant of the first embodiment of FIG. 1, the apparatus of FIG. 1 comprises an interface 110 for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission.

Moreover, the apparatus comprises a decoding unit 120, wherein the decoding unit 120 is configured to decode the packet payload of each one of at least one ATSC Link-layer Protocol packet of the plurality of ATSC Link-layer Protocol packets to obtain the digital content of said one of the at least one ATSC Link-layer Protocol packet.

One or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments.

Each table fragment of the one or more table fragments of each table of one or more tables comprises table management information which comprises management information for said table fragment and/or for said table, wherein the table management information comprises information on one or more management parameters.

According to an embodiment, at least one table of the one or more tables may, e.g., comprise two or more table fragments. Information on at least one of the one or more management parameters is present in each of the two or more table fragments.

In an embodiment, the one or more management parameters comprise a plurality of management parameters. Information on each of the plurality of management parameters is present in each of the two or more table fragments.

According to an embodiment, at least one table fragment of the one or more table fragments of a table of the one or more tables may, e.g., comprise, as the information on one of the one or more management parameters, a value for a data revision parameter for said table. The decoding unit 120 may, e.g., be configured to compare a current revision number for said table stored at the decoding unit 120 and the value for said data revision parameter for said table of the at least one table fragment to determine whether or not updating stored information for said table stored at the decoding unit 120 is needed.

In an embodiment, each one of at least one table fragment of the one or more table fragments of a table of the one or more tables may, e.g., comprise, as the information on another one of the one or more management parameters, a value for a fragment data revision parameter for said one of the at least one table fragment. The decoding unit 120 may, e.g., be configured to compare a current revision number for said table fragment stored at the decoding unit 120 and the value for said fragment data revision parameter for said table fragment to determine whether or not updating stored information for said table fragment stored at the decoding unit 120 is needed.

According to an embodiment, a body section of at least one of the one or more table fragments of at least one table the of one or more tables is compressed.

In an embodiment, each table fragment of the one or more table fragments of said at least one table may, e.g., comprise, as the information on a further one of the one or more management parameters, a compression value indicating whether or not the body section of said table fragment is compressed.

According to an embodiment, the decoding unit 120 may, e.g., be configured to decompress the body section of a table fragment of said at least one of the one or more table fragments, if the decoding unit 120 has determined that updating the stored information for said table fragment stored at the decoding unit 120 is needed. The decoding unit 120 may, e.g., be configured to not decompress the body section of said table fragment, if the decoding unit 120 has determined that updating the stored information for said table fragment stored at the decoding unit 120 is not necessary.

In an embodiment, each one of at least one table fragment of the one or more table fragments of a table of the one or more tables may, e.g., comprise revision table information for said table. The revision table information for said table indicates a value for a fragment data revision parameter of each table fragment of the one or more table fragments of said table in the ATSC transmission.

According to an embodiment, the decoding unit 120 may, e.g., be configured to compare a current revision number for said table fragment stored at the decoding unit 120 and the value for said fragment data revision parameter for said table fragment to determine whether or not updating stored information for said table fragment stored at the decoding unit 120 is needed.

In an embodiment, the revision table information for said table indicates a location of each of the one or more table fragments of said table in the ATSC transmission.

According to an embodiment, the revision table information for said table indicates the location of each table fragment of the one or more table fragments of said table in the ATSC transmission by indicating a physical layer pipe and/or by indicating an ATSC Link-layer Protocol packet, which comprise said table fragment.

In an embodiment, the decoding unit 120 may, e.g., be configured to obtain said table fragment from its location in the ATSC transmission, if the decoding unit 120 has determined that updating the stored information for said table fragment stored at the decoding unit 120 is needed. The decoding unit 120 may, e.g., be configured to not obtain said table fragment from its location in the ATSC transmission, if the decoding unit 120 has determined that updating the stored information for said table fragment stored at the decoding unit 120 is not necessary.

According to an embodiment, the one or more table fragments of each of one or more tables comprise the one or more fragments of the Link Mapping Table for services.

In an embodiment, the one or more table fragments of each of one or more tables comprise the one or more fragments of the Link Mapping Table for Service Grouping.

According to an embodiment, one or more table fragments of each of one or more tables comprise one or more fragments of a Logo/Icon Table (LIT) comprising information on one or more versions of a logo or icon. And/or, one or more table fragments of each of one or more tables comprise one or more fragments of a Logo/Icon Variant (LIV) comprising image data of a version of a logo or icon.

In an embodiment, a first table of the one or more tables exhibits a first table type, wherein a second table of one or more tables exhibits a second table type being different from the first table type. The decoding unit 120 may, e.g., be configured to decode the one or more table fragments of the first table and the one or more table fragments of the second table using a same decoding algorithm.

According to an embodiment, the first table exhibits one of a group of at least four table types, which comprise the table types:
Link Mapping Table for radio services (LMT-R),
Link Mapping Table for Service Grouping (LMT-R-SG),
Logo/Icon Table (LIT),
Logo/Icon Variant (LIV).

The second table exhibits a different one of the group of the at least four table types.

FIG. 2 illustrates an apparatus for generating a plurality of ATSC Link-layer Protocol packets according to an embodiment.

The apparatus comprises an interface 210 for receiving input data.

Moreover, the apparatus comprises a packet generator 220 for generating the plurality of ATSC Link-layer Protocol packets depending on the input data, such that each of the plurality of ATSC Link-layer Protocol packets may, e.g., comprise a packet header and a packet payload encapsulating digital content.

In a first embodiment, the packet generator 220 is configured to generate one or more ATSC Link-layer Protocol packets of the plurality of ATSC Link-layer Protocol packets, such that the digital content being encapsulated within the packet payload of each of the one or more ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

According to an embodiment, the packet generator 220 may, e.g., be configured to generate an ATSC Link-layer Protocol packet of the one or more ATSC Link-layer Protocol packets, such that the digital content being encapsulated within said ATSC Link-layer Protocol packet may, e.g., comprise digital radio content.

In an embodiment, the packet generator 220 may, e.g., be configured to generate an ATSC Link-layer Protocol packet of the one or more ATSC Link-layer Protocol packets, such that the digital content being encapsulated within said ATSC Link-layer Protocol packet may, e.g., comprise a Distribution and Communications Protocol packet or a portion thereof.

According to an embodiment, the Distribution and Communications Protocol packet or the portion thereof being encapsulated within the packet payload of said ATSC Link-layer Protocol packet may, e.g., comprise digital radio content.

In an embodiment, the digital radio content may, e.g., comprise Digital Radio Mondial content.

According to an embodiment, the packet generator 220 may, e.g., be configured to generate an ATSC Link-layer Protocol packet of the one or more ATSC Link-layer Protocol packets, such that the digital content being encapsulated within said ATSC Link-layer Protocol packet may, e.g., comprise Unified Speech and Audio Coding content or extended High Efficiency Advanced Audio Coding content.

In an embodiment, the packet generator 220 may, e.g., be configured to generate an ATSC Link-layer Protocol packet of the one or more ATSC Link-layer Protocol packets, such that the digital content being encapsulated within said ATSC Link-layer Protocol packet may, e.g., comprise Journaline content.

According to an embodiment, the packet generator 220 may, e.g., be configured to generate the plurality of ATSC Link-layer Protocol packets, such that one or more further ATSC Link-layer Protocol packets of the plurality of ATSC Link-layer Protocol packets comprise one or more fragments of a Link Mapping Table for services. The one or more fragments of the Link Mapping Table for services indicate one or more services of an ATSC transmission.

In a first variant of the apparatus of FIG. 2, the apparatus of FIG. 2 comprises an interface 210 for receiving input data.

Moreover, the apparatus comprises a packet generator 220 for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The packet generator 220 is configured to generate the plurality of ATSC Link-layer Protocol packets, such that one or more further ATSC Link-layer Protocol packets of the plurality of ATSC Link-layer Protocol packets comprise one or more fragments of a Link Mapping Table for services, wherein the one or more fragments of the Link Mapping Table for services indicate the one or more services of the ATSC transmission.

In an embodiment, the one or more fragments of the Link Mapping Table for services are one or more fragments of a Link Mapping Table for radio services. The one or more fragments of the Link Mapping Table for radio services indicate one or more radio services of the ATSC transmission.

According to an embodiment, the packet generator 220 may, e.g., be configured to generate the one or more further ATSC Link-layer Protocol packets, such that the one or more fragments of the Link Mapping Table for radio services comprise metadata for the one or more radio services of the ATSC transmission.

In an embodiment, at least some of the plurality of ATSC Link-layer Protocol packets encapsulate a plurality of Distribution and Communications Protocol packets comprising the one or more radio services of the ATSC transmission.

According to an embodiment, the packet generator 220 may, e.g., be configured to generate the one or more further ATSC Link-layer Protocol packets, such that the metadata for the one or more radio services may, e.g., comprise information on a service label, and/or information on a multiplex label, and/or information on a language, and/or information on a program type, and/or information on a region, and/or information on a country of origin, and/or audio configuration information, and/or a data application identifier.

In an embodiment, the packet generator 220 may, e.g., be configured to generate the one or more further ATSC Link-layer Protocol packets, such that the one or more fragments of the Link Mapping Table for radio services are one or more fragments of the Link Mapping Table for Digital Radio Mondiale-Radio, wherein the one or more fragments of the Link Mapping Table for Digital Radio Mondiale-Radio indicate one or more Digital Radio Mondiale radio services of the ATSC transmission.

According to an embodiment, the packet generator 220 may, e.g., be configured to generate the one or more further ATSC Link-layer Protocol packets, such that the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams.

In an embodiment, the packet generator 220 may, e.g., be configured to generate the one or more further ATSC Link-layer Protocol packets, such that the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

According to an embodiment, the packet generator 220 may, e.g., be configured to analyse one or more Digital Radio Mondiale Multiplex Distribution Interface streams, which are associated with the one or more Digital Radio Mondiale radio services. The packet generator 220 may, e.g., be configured to generate the one or more further ATSC Link-layer Protocol packets, such that the metadata for one of the one or more Digital Radio Mondiale radio services corresponds to metadata being comprised by one of the one or more Digital Radio Mondiale Multiplex Distribution Interface streams, which are associated with the one or more Digital Radio Mondiale radio services.

In an embodiment, the packet generator 220 may, e.g., be configured to analyse one or more Digital Radio Mondiale Multiplex Distribution Interface streams, which are associated with the one or more Digital Radio Mondiale radio services. The packet generator 220 may, e.g., be configured to generate the one or more further ATSC Link-layer Protocol packets, such that the one or more fragments of the Link Mapping Table for radio services comprise emergency warning information indicating whether or not an emergency warning is indicated by at least one of the one or more Digital Radio Mondiale Multiplex Distribution Interface streams, which are associated with the one or more Digital Radio Mondiale radio services.

According to an embodiment, the packet generator 220 may, e.g., be configured to generate the plurality of ATSC Link-layer Protocol packets, such that, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets may, e.g., comprise a same sub-stream identifier being associated with the Digital Radio Mondiale Multiplex Distribution Interface stream.

In an embodiment, the one or more fragments of the Link Mapping Table for radio services are one or more fragments of the Link Mapping Table for Digital Audio Broadcasting. The one or more fragments of the Link Mapping Table for Digital Audio Broadcasting indicate one or more Digital Audio Broadcasting services of the ATSC transmission.

According to an embodiment, the one or more fragments of the Link Mapping Table for Digital Audio Broadcasting indicate an association of at least one of the one or more Digital Audio Broadcasting services with one or more EDI (Encapsulation of DAB Interfaces) streams.

In an embodiment, the one or more further ATSC Link-layer Protocol packets are two or more further ATSC Link-layer Protocol packets, wherein the one or more fragments are two or more fragments, wherein the one or more services are a plurality of services. The packet generator 220 may, e.g., be configured to generate the two or more further ATSC Link-layer Protocol packets, such that the two or more further ATSC Link-layer Protocol packets comprise the two or more fragments of the Link Mapping Table for services, wherein the two or more fragments of the Link Mapping Table for services indicate the plurality of services of the ATSC transmission.

According to an embodiment, the apparatus may, e.g., be configured to repeatedly transmit the one or more ATSC Link-layer Protocol packets which comprise the one or more fragments of the Link Mapping Table for services.

In an embodiment, the packet generator 220 may, e.g., be configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

In a second variant of the apparatus of FIG. 2, the apparatus of FIG. 2 comprises an interface 210 for receiving input data.

Moreover, the apparatus of FIG. 2 comprises a packet generator 220 for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The packet generator 220 is configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

According to an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission.

In an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission.

According to an embodiment, the one or more fragments of the Link Mapping Table for Service Grouping are one or more fragments of a Link Mapping Table for Digital Audio Broadcasting Service Grouping. The one or more fragments of the Link Mapping Table for Digital Audio Broadcasting Service Grouping indicate one or more groupings of a plurality of Digital Audio Broadcasting services of the ATSC transmission.

In an embodiment, the one or more still further ATSC Link-layer Protocol packets are two or more still further ATSC Link-layer Protocol packets, wherein the one or more fragments of the Link Mapping Table for Service Grouping are two or more fragments, wherein the packet generator 220 may, e.g., be configured to generate the two or more still further ATSC Link-layer Protocol packets, such that the two or more still further ATSC Link-layer Protocol packets comprise the two or more fragments of the Link Mapping Table for Service Grouping.

According to an embodiment, the packet generator 220 may, e.g., be configured to generate the one or more still further ATSC Link-layer Protocol packets, such that the one or more fragments of the Link Mapping Table for Service Grouping associate two or more of the plurality of services with at least one of two or more categories, and/or with at least one of two or more properties.

In an embodiment, the packet generator 220 may, e.g., be configured to generate the one or more still further ATSC Link-layer Protocol packets, such that the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

According to an embodiment, the packet generator 220 may, e.g., be configured to generate the one or more still further ATSC Link-layer Protocol packets, such that the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

In an embodiment, the apparatus may, e.g., be configured to repeatedly transmit the one or more still further ATSC Link-layer Protocol packets which comprise the one or more fragments of the Link Mapping Table for Service Grouping.

According to an embodiment, the packet generator 220 may, e.g., be configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments may, e.g., comprise metadata supporting a selection of a service, and/or may, e.g., comprise information on a content of the payload of each of one or more of the plurality of ATSC Link-layer Protocol packets, and/or may, e.g., comprise information on another one of the one or more table fragments. Each table fragment of the one or more table fragments of each table of one or more tables may, e.g., comprise table management information which may, e.g., comprise management information for said table fragment and/or for said table, wherein the table management information may, e.g., comprise information on one or more management parameters.

In a third variant of the apparatus of FIG. 2, the apparatus of FIG. 2 comprises an interface 210 for receiving input data.

Moreover, the apparatus comprises a packet generator 220 for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The packet generator 220 is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments.

Each table fragment of the one or more table fragments of each table of one or more tables comprises table management information which comprises management information for said table fragment and/or for said table, wherein the table management information comprises information on one or more management parameters.

According to an embodiment, at least one table of the one or more tables may, e.g., comprise two or more table fragments. Information on at least one of the one or more management parameters is present in each of the two or more table fragments.

In an embodiment, the one or more management parameters comprise a plurality of management parameters. Information on each of the plurality of management parameters is present in each of the two or more table fragments.

According to an embodiment, at least one table fragment of the one or more table fragments of a table of the one or more tables may, e.g., comprise, as the information on one of the one or more management parameters, a value for a data revision parameter for said table.

In an embodiment, each one of at least one table fragment of the one or more table fragments of a table of the one or more tables may, e.g., comprise, as the information on another one of the one or more management parameters, a value for a fragment data revision parameter for said one of the at least one table fragment.

According to an embodiment, the packet generator 220 may, e.g., be configured to generate the plurality of ATSC Link-layer Protocol packets, such that a body section of at least one of the one or more table fragments of at least one table the of one or more tables is compressed.

In an embodiment, each table fragment of the one or more table fragments of said at least one table may, e.g., comprise, as the information on a further one of the one or more management parameters, a compression value indicating whether or not the body section of said table fragment is compressed.

According to an embodiment, the packet generator 220 may, e.g., be configured to generate the plurality of ATSC Link-layer Protocol packets, such that each one of at least one table fragment of the one or more table fragments of a table of the one or more tables may, e.g., comprise revision table information for said table. The revision table information for said table indicates a value for a fragment data revision parameter of each table fragment of the one or more table fragments of said table in the ATSC transmission.

In an embodiment, the revision table information for said table indicates a location of each of the one or more table fragments of said table in the ATSC transmission.

According to an embodiment, the revision table information for said table indicates the location of each table fragment of the one or more table fragments of said table in the ATSC transmission by indicating a physical layer pipe and/or by indicating an ATSC Link-layer Protocol packet, which comprise said table fragment.

In an embodiment, the one or more table fragments of each of one or more tables comprise the one or more fragments of the Link Mapping Table for services.

According to an embodiment, the one or more table fragments of each of one or more tables comprise the one or more fragments of the Link Mapping Table for Service Grouping.

In an embodiment, one or more table fragments of each of one or more tables comprise one or more fragments of a Logo/Icon Table (LIT) comprising information on one or more versions of a logo or icon. And/or, one or more table fragments of each of one or more tables comprise one or more fragments of a Logo/Icon Variant (LIV) comprising image data of a version of a logo or icon.

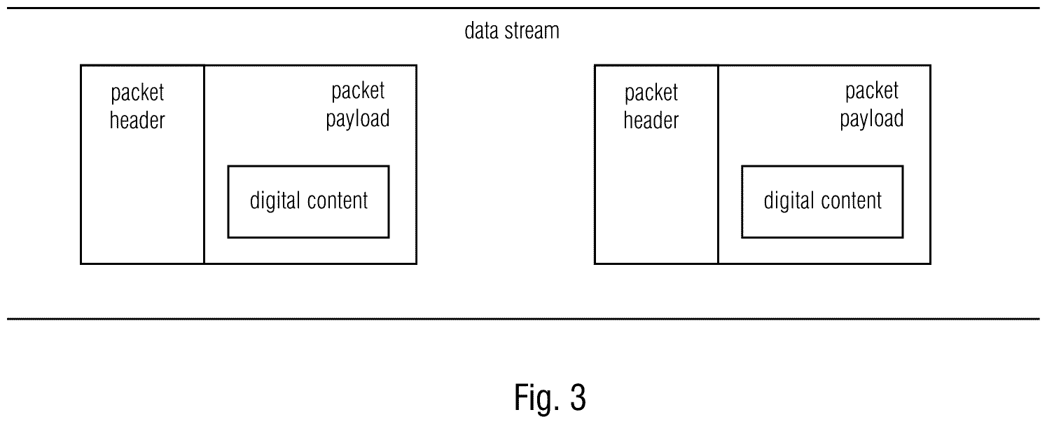

FIG. 3 illustrates a data stream comprising a plurality of ATSC Link-layer Protocol packets according to an embodiment.

Each of the plurality of ATSC Link-layer Protocol packets comprises a packet header and a packet payload encapsulating digital content.

According to a first embodiment, the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

According to an embodiment, the digital content being encapsulated within said ATSC Link-layer Protocol packet may, e.g., comprise digital radio content.

In an embodiment, the digital content being encapsulated within said ATSC Link-layer Protocol packet may, e.g., comprise a Distribution and Communications Protocol packet or a portion thereof.

According to an embodiment, the Distribution and Communications Protocol packet or the portion thereof being encapsulated within the packet payload of said ATSC Link-layer Protocol packet may, e.g., comprise digital radio content.

In an embodiment, the digital radio content may, e.g., comprise Digital Radio Mondial content.

According to an embodiment, the digital content being encapsulated within said ATSC Link-layer Protocol packet may, e.g., comprise Unified Speech and Audio Coding content or extended High Efficiency Advanced Audio Coding content.

In an embodiment, the digital content being encapsulated within said ATSC Link-layer Protocol packet may, e.g., comprise Journaline content.

According to an embodiment, the data stream may, e.g., comprise one or more further ATSC Link-layer Protocol packets of the plurality of ATSC Link-layer Protocol packets, which comprise one or more fragments of a Link Mapping Table for services. The one or more fragments of the Link Mapping Table for services indicate one or more services of an ATSC transmission.

In a first variant of the data stream of FIG. 3, each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The data stream comprises one or more ATSC Link-layer Protocol packets of the plurality of ATSC Link-layer Protocol packets, which comprise one or more fragments of a Link Mapping Table for services.

The one or more fragments of the Link Mapping Table for services indicate the one or more services of the ATSC transmission.

According to an embodiment, the one or more fragments of the Link Mapping Table for services are one or more fragments of a Link Mapping Table for radio services. The one or more fragments of the Link Mapping Table for radio services indicate one or more radio services of the ATSC transmission.

In an embodiment, the one or more fragments of the Link Mapping Table for radio services comprise metadata for the one or more radio services of the ATSC transmission.

According to an embodiment, at least some of the plurality of ATSC Link-layer Protocol packets encapsulate a plurality of Distribution and Communications Protocol packets comprising the one or more radio services of the ATSC transmission.

In an embodiment, the metadata for the one or more radio services may, e.g., comprise information on a service label, and/or information on a multiplex label, and/or information on a language, and/or information on a program type, and/or information on a region, and/or information on a country of origin, and/or audio configuration information, and/or a data application identifier.

According to an embodiment, the one or more fragments of the Link Mapping Table for radio services are one or more fragments of the Link Mapping Table for Digital Radio Mondiale-Radio, wherein the one or more fragments of the Link Mapping Table for Digital Radio Mondiale-Radio indicate one or more Digital Radio Mondiale radio services of the ATSC transmission.

In an embodiment, the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams.

According to an embodiment, the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

In an embodiment, the metadata for one of the one or more Digital Radio Mondiale radio services corresponds to metadata being comprised by one of one or more Digital Radio Mondiale Multiplex Distribution Interface streams, which are associated with the one or more Digital Radio Mondiale radio services.

According to an embodiment, the one or more fragments of the Link Mapping Table for radio services comprise emergency warning information indicating whether or not an emergency warning is indicated by at least one of one or more Digital Radio Mondiale Multiplex Distribution Interface streams, which are associated with the one or more Digital Radio Mondiale radio services.

In an embodiment, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets may, e.g., comprise a same sub-stream identifier being associated with the Digital Radio Mondiale Multiplex Distribution Interface stream.

According to an embodiment, the one or more fragments of the Link Mapping Table for radio services are one or more fragments of the Link Mapping Table for Digital Audio Broadcasting. The one or more fragments of the Link Mapping Table for Digital Audio Broadcasting indicate one or more Digital Audio Broadcasting services of the ATSC transmission.

In an embodiment, the one or more fragments of the Link Mapping Table for Digital Audio Broadcasting indicate an association of at least one of the one or more Digital Audio Broadcasting services with one or more EDI (Encapsulation of DAB Interfaces) streams.

According to an embodiment, the one or more further ATSC Link-layer Protocol packets are two or more further ATSC Link-layer Protocol packets, wherein the one or more fragments are two or more fragments, wherein the one or more services are a plurality of services. The two or more further ATSC Link-layer Protocol packets comprise the two or more fragments of the Link Mapping Table for services, wherein the two or more fragments of the Link Mapping Table for services indicate the plurality of services of the ATSC transmission.

In an embodiment, the data stream may, e.g., comprise one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission.

In a second variant of the data stream of FIG. 3, each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

The data stream comprises one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission.

According to an embodiment, the one or more fragments of the Link Mapping Table for Service Grouping are one or more fragments of a Link Mapping Table for Radio Service Grouping. The one or more fragments of the Link Mapping Table for Radio Service Grouping indicate one or more groupings of a plurality of radio services of the ATSC transmission.

In an embodiment, the one or more fragments of the Link Mapping Table for Service Grouping are one or more fragments of a Link Mapping Table for Digital Radio Mondiale-Radio Service Grouping. The one or more fragments of the Link Mapping Table for Digital Radio Mondiale-Radio Service Grouping indicate one or more groupings of a plurality of Digital Radio Mondiale radio services of the ATSC transmission.

According to an embodiment, the one or more fragments of the Link Mapping Table for Service Grouping are one or more fragments of a Link Mapping Table for Digital Audio Broadcasting Service Grouping. The one or more fragments of the Link Mapping Table for Digital Audio Broadcasting Service Grouping indicate one or more groupings of a plurality of Digital Audio Broadcasting services of the ATSC transmission.

In an embodiment, the one or more still further ATSC Link-layer Protocol packets are two or more still further ATSC Link-layer Protocol packets, wherein the one or more fragments of the Link Mapping Table for Service Grouping are two or more fragments,

wherein the two or more still further ATSC Link-layer Protocol packets comprise the two or more fragments of the Link Mapping Table for Service Grouping.

According to an embodiment, the one or more fragments of the Link Mapping Table for Service Grouping associate two or more of the plurality of services with at least one of two or more categories, and/or with at least one of two or more properties.

In an embodiment, the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

According to an embodiment, the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

In an embodiment, one or more other ATSC Link-layer Protocol packets of the plurality of ATSC Link-layer Protocol packets comprise one or more table fragments of each of one or more tables, wherein each of the one or more table fragments may, e.g., comprise metadata supporting a selection of a service, and/or may, e.g., comprise information on a content of the payload of each of one or more of the plurality of ATSC Link-layer Protocol packets, and/or may, e.g., comprise information on another one of the one or more table fragments. Each table fragment of the one or more table fragments of each table of one or more tables may, e.g., comprise table management information which may, e.g., comprise management information for said table fragment and/or for said table, wherein the table management information may, e.g., comprise information on one or more management parameters.

In a third variant of the data stream of FIG. 3, each of the plurality of ATSC Link-layer Protocol packets comprises a packet header and a packet payload encapsulating digital content, wherein one or more of the plurality of ATSC Link-layer Protocol packets comprises content of one or more services of an ATSC transmission.

One or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments.

Each table fragment of the one or more table fragments of each table of one or more tables comprises table management information which comprises management information for said table fragment and/or for said table, wherein the table management information comprises information on one or more management parameters.

According to an embodiment, at least one table of the one or more tables may, e.g., comprise two or more table fragments. Information on at least one of the one or more management parameters is present in each of the two or more table fragments.

In an embodiment, the one or more management parameters comprise a plurality of management parameters. Information on each of the plurality of management parameters is present in each of the two or more table fragments.

According to an embodiment, at least one table fragment of the one or more table fragments of a table of the one or more tables may, e.g., comprise, as the information on one of the one or more management parameters, a value for a data revision parameter for said table.

In an embodiment, each one of at least one table fragment of the one or more table fragments of a table of the one or more tables may, e.g., comprise, as the information on another one of the one or more management parameters, a value for a fragment data revision parameter for said one of the at least one table fragment.

According to an embodiment, a body section of at least one of the one or more table fragments of at least one table the of one or more tables is compressed.

In an embodiment, each table fragment of the one or more table fragments of said at least one table may, e.g., comprise, as the information on a further one of the one or more management parameters, a compression value indicating whether or not the body section of said table fragment is compressed.

According to an embodiment, each one of at least one table fragment of the one or more table fragments of a table of the one or more tables may, e.g., comprise revision table information for said table. The revision table information for said table indicates a value for a fragment data revision parameter of each table fragment of the one or more table fragments of said table in the ATSC transmission.

In an embodiment, the revision table information for said table indicates a location of each of the one or more table fragments of said table in the ATSC transmission.

According to an embodiment, the revision table information for said table indicates the location of each table fragment of the one or more table fragments of said table in the ATSC transmission by indicating a physical layer pipe and/or by indicating an ATSC Link-layer Protocol packet, which comprise said table fragment.

In an embodiment, the one or more table fragments of each of one or more tables comprise the one or more fragments of the Link Mapping Table for services.

According to an embodiment, the one or more table fragments of each of one or more tables comprise the one or more fragments of the Link Mapping Table for Service Grouping.

In an embodiment, one or more table fragments of each of one or more tables comprise one or more fragments of a Logo/Icon Table (LIT) comprising information on one or more versions of a logo or icon. And/or, one or more table fragments of each of one or more tables comprise one or more fragments of a Logo/Icon Variant (LIV) comprising image data of a version of a logo or icon.

Moreover, a system is provided. The system comprises an apparatus for generating a plurality of ATSC Link-layer Protocol packets according to one of the above-described embodiments, and an apparatus for decoding, wherein the apparatus for decoding is configured to receive and decode the plurality of ATSC Link-layer Protocol packets according to one of the above-described embodiments.

In the following, particular embodiments of the present invention are described.

Some embodiments relate to new and inventive extensions of ATSC.

At first DCP Packet encapsulation is described.

This section specifies the ALP packet format when the input consists of DCP packets [3], that is, when the packet_type field of the Base Header is equal to ‘101’. DCP packets are used, for example, for the transport of DRM Digital Radio Mondiale (DRM-Radio) [4] MDI streams [5].

Now, DCP Packets are described.

DCP, the standardized Distribution & Communication Protocol, enables the uni-directional transport of stream-based information as a sequence of DCP packets.

Each DCP packet represents a certain segment of the stream-based content. It consists of either one Application Framing (AF) packet or one Protection, Fragmentation and Transportation (PFT) Fragment (encapsulating AF packets for additional functionality). The optional PFT layer allows enhancing the AF layer by adding forward error correction capabilities and addressing and fragmentation capabilities, e.g., to cope with limitations of an underlying transport protocol such as UDP/IP. Application of the PFT layer often will split a single AF packet into a sequence of PFT Fragments, with the single AF packet or each PFT Fragment representing an independent DCP packet for the purpose of this specification.

Next, an ALP Packet Structure (for DCP Packet Encapsulation) is described.

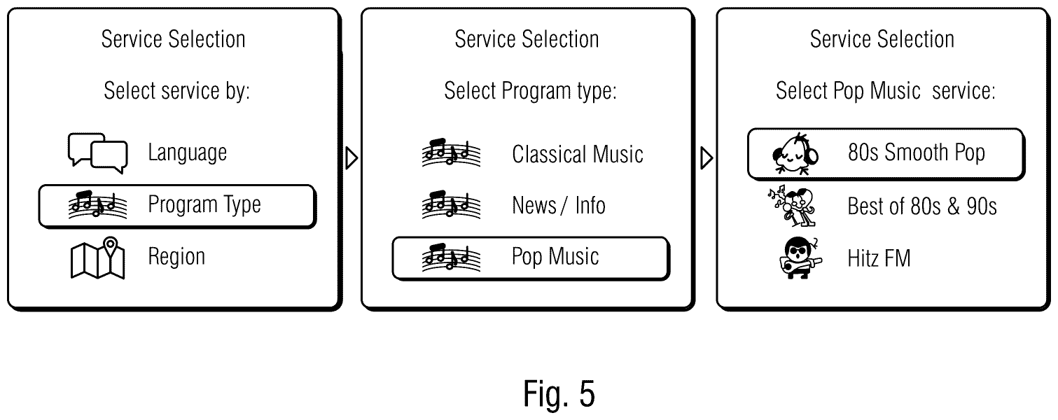

The overall structure of an ALP packet header when encapsulating DCP packets is depicted in FIG. 5.2 in combination with FIG. 5.3, FIG. 5.4, or FIG. 5.5 and is described in Table 5.1 and Table 5.2 in combination with Table 5.4, Table 5.5, or Table 5.6 and the text following the respective tables of [1]. The following conditions apply.

ALP packets carrying a DCP packet sequence representing an individual stream-based content shall be identified by a single unique Sub-stream Identifier (SID). The SID value is carried in each ALP packet's Header Extension. Consequently, when the payload_configuration (PC) bit is set to ‘0’, the header_mode (HM) bit in the ALP packet's Base Header shall be set to ‘1’, to indicate the presence of the Additional Header. The Sub-stream Identifier Flag (SIF) in the Additional Header also shall be set to ‘1’ to indicate the presence of Extension Header carrying the SID. When the PC bit is set to ‘1’, both states of the segmentation_concatenation (S/C) bit indicate the presence of an Additional Header, which shall have its SIF bit set to ‘1’ to indicate the presence of the Extension Header carrying the SID. In each case, the ALP packet's Header Extension then carries as its first 8 bits the SID value, ranging from 0-255 as described in clause 5.1.3.1 of [1], to indicate the specific ALP Sub-stream with which the packet is associated.

The overall structure of the header of an ALP packet carrying a DCP packet therefore comprises at least 4 bytes: two bytes for a Base Header, one byte for an Additional Header, and one byte for the Extension Header carrying the SID value. The Extension Header may be elongated with a variable number of additional bytes, if signaled by the Header Extension Flag (HEF) bit in the Additional Header being set to ‘1’.

Now, DRM-Radio MDI, an application based on DCP Packets, is described.

Radio services in ATSC 3.0 shall be based on the DRM Digital Radio Mondiale standard [4] and shall be transported in the MDI stream format (DRM Multiplex Distribution Interface) [5], which, in turn, is based on the DCP standard [3]. A DRM-Radio MDI stream carries between one and four audio/multimedia DRM-Radio Services along with all directly-related signaling.

Each DRM-Radio MDI stream is transported as a sequence of DCP packets. ALP packets carrying DCP packets representing a single DRM-Radio MDI stream are identified by a single, unique Sub-stream Identifier (SID).

Multiple consecutive DCP packets carrying the same MDI stream can be encapsulated into a single ALP packet using the concatenation method described in clause 5.1.2.3 of [1]. Conversely, a single DCP packet carrying an MDI stream can be encapsulated in multiple ALP packets using the segmentation method described in clause 5.1.2.2 of [1]. Because of the efficiency of the underlying DRM-Radio signaling and data packaging mechanisms, no further data reduction or header compression would be beneficial, and consequently, none is applied.

In the following, Link Layer Signaling according to embodiments are described. A general overview on Link Layer Signaling in ATSC is provided in clause 7 of [1].

At first, a Link Mapping Table for DRM-Radio (LMT-R) according to some embodiments is described.

Described is the general LMT-R layout for DCP-based DRM-Radio Services. The general LMT format for IP-based Services is defined in clause 7.1.1 of [1].

The Link Mapping Table for DRM-Radio (LMT-R) provides a list of DRM digital radio Services carried in the ATSC 3.0 broadcast, along with their descriptions and instructions where in the ATSC 3.0 multiplex to find the DRM-Radio MDI streams carrying the Services. It provides sufficient information for building a Service guide for all DRM digital radio Services. It can reference station Logos and Service Logos to support visual Service discovery and selection. It supports grouping of DRM Services by Categories and Properties, allowing for a more convenient discovery and selection or filtering of radio Services grouped for example by radio broadcaster, language, region, country of origin, program type, multimedia application type, targeted age group, or in other ways.

Provision is made in the LMT-R structure for inclusion of textual labels for presentation within Service guides and for other uses derived from information carried in LMT-R Fragments. Such Labels shall be included to let users identify specific DRM-Radio Services and, optionally, DRM Multiplexes for easier Service selection. In each case, the label characters shall be coded in the UCS codespace and signaled in one to four octets, as specified for the UTF-8 encoding form and the UTF-8 encoding scheme in ISO/IEC 10646 [9]. The number of UTF-8-defined octets used to code the labels shall be limited to 64, and presentation of the complement of characters in a label shall be limited to 32 characters. Inclusion of both left-to-right and right-to-left characters and bi-directional text segments shall be permitted, exclusively by use of the Unicode control characters LRI, RLI and PDI. The base direction for a given label, as well as local changes of direction within the label shall be coded according to the DRM service label specification, including the leading text control field as the first byte of the string if needed (see [4]). The sets of UCS code points (scripts) to be supported will vary depending on the target market (see DRM Regional Profiles [11]).

LMT-R shall be communicated in Fragments, with each Fragment occupying a separate ALP packet. LMT-R fragmentation can be applied for a variety of reasons, including enabling the multiplexing of content from a multiplicity of sources: Multiple, independent LMT-R Fragments may be present, e.g., to provide signaling capacity for larger numbers of DRM-Radio Services than can be listed in a single Fragment, or to carry service discovery information for individual radio broadcast networks separately. LMT-R Fragments may be carried in multiple PLPs. All LMT-R Fragments, taken together, shall describe the full set of available DRM-Radio Services carried in an ATSC 3.0 transmission. Each MDI stream carrying DRM-Radio Services shall be described in only a single LMT-R Fragment. The LMT-R Fragment describing an MDI stream may be carried in the same PLP as the MDI stream itself, or in another PLP.

At least the LMT-R Fragment with lowest index value carried in a given PLP shall carry a table indicating the locations and revision statuses of all Fragments, including those carried outside the current PLP.

If a PLP carries at least one LMT-R Fragment, it shall be flagged as carrying LLS by the value of the related L1D_plp_lls_flag being set to ‘1’ (see A/322 [1] Section 9.3.4).

LMT-R Fragments shall be carried in individual ALP packets; only ALP single-packet headers shall be applied to them. They shall not be segmented or concatenated and shall be limited to 65,535 bytes of payload prior to application of any compression. Thus, in the headers of ALP packets carrying LMT-R Fragments, PC shall be set to ‘0’ and HM shall be set to ‘1’. The Body Sections of LMT-R Fragments should be compressed using gzip [8], but compression shall be applied to an LMT-R Fragment only if doing so results in an overall reduction of the size of the Fragment.

All Fragments constituting a complete LMT-R should be repeated at least once every second; but in any case, they shall be repeated at a rate of at least once every 5 seconds. When present, the LMT-R should be broadcast at the same rate as the SLT.

When carrying an LMT-R Fragment, an ALP packet's Base Header packet_type value shall be ‘100’ (Link layer signaling packet). The values for the Additional Headers of ALP packets carrying LMT-R Fragments, which are defined in Table 5.11, shall be as given in Table 7.6. The syntax of an LMT-R Fragment itself shall be as given in Table 7.7, and semantics of an LMT-R Fragment shall be as described in the text section following Table 7.7.

TABLE 7.6
ALP Packet Additional Header Values for LMT-R

| Fields in Additional Header for Signaling | No. of bits | Value |
|---|---|---|
| signaling_type | 8 | 0x03 |
| signaling_type_extension | 16 | 0xFFFF |
| signaling_format | 2 | 00 |
| signaling_encoding | 2 | 00 |

TABLE 7.7
Syntax for Link Mapping Table for DRM-Radio (LMT-R)
Fragments

| Syntax | No. of bits | Format |
|---|---|---|
| link_mapping_table_fragment_drm-r( ) { | | |
| Fragment Management Section: | | |
| lmt-r_version | 2 | uimsbf |
| drm_ewf_active_flag | 1 | bslbf |
| reserved | 1 | ‘1’ |
| lmt-r_data_revision | 4 | uimsbf |
| num_fragments_minus1 | 11 | uimsbf |
| fragment_index | 11 | uimsbf |
| fragment_data_revision | 4 | uimsbf |
| fragment_extension_flag | 1 | bslbf |
| fragment_compression_flag | 1 | bslbf |
| revision_table_use_flag | 1 | bslbf |
| reserved | 3 | ‘111’ |
| Start of LMT-R Fragment “Body Section”: | | |
| if (revision_table_use_flag==1) { | | |
| for (i = 0; i <= num_fragments_minus1; ++i) { | | |
| reserved | 2 | ‘11’ |
| rt_fragment_plp_id | 6 | uimsbf |
| rt_fragment_data_revision | 4 | uimsbf |
| } | | |
| if (is_even_number(num_fragments_minus1) { | | ‘1111’ |
| rt_byte_alignment | 4 | |
| } | | |
| } | | |
| Start of LMT-R Fragment “Payload Section”: | | |
| servicegrouping_use_flag | 1 | bslbf |
| reserved | 1 | ‘1’ |
| if (servicegrouping_use_flag == 1) { | | |
| lmt-r-sg_plp_id | 6 | uimsbf |
| lmt-r-sg_revision | 4 | uimsbf |
| reserved | 4 | ‘1111’ |
| } else { | | |
| reserved | 6 | ‘111111’ |
| } | | |
| single_logo_substream_flag | 1 | bslbf |
| reserved | 1 | ‘1’ |
| if (single_logo_substream_flag == 1) { | | |
| single_logo_plp_id | 6 | uimsbf |
| } else { | | |
| reserved | 6 | ‘111111’ |
| } | | |
| num_mdi_streams_minus1 | 8 | uimsbf |
| for (i=0; i <= num_mdi_streams_minus1; i++) { | | |
| mux_label_flag | 1 | bslbf |
| mux_logo_flag | 1 | bslbf |
| mux_plp_id | 6 | uimsbf |
| mux_alp_sid | 8 | uimsbf |
| if (mux_label_flag==1) { | | |
| reserved | 2 | ‘11’ |
| mux_label_size_minus1 | 6 | uimsbf |
| mux_label | 8 × (size) | bslbf |
| } | | |
| if (mux_logo_flag==1) { | | |
| logo_id | 16 | uimsbf |
| if (single_logo_substream_flag == 0) { | | |
| reserved | 2 | ‘11’ |
| logo_plp_id | 6 | uimsbf |
| } | | |
| } | | |
| reserved | 6 | ‘111111’ |
| num_services_minus1 | 2 | uimsbf |
| for (j=0; j <=num_ services_minus1; j++) { | | |
| service_id | 24 | uimsbf |
| ca_flag_audio | 1 | bslbf |
| ca_flag_data | 1 | bslbf |
| audio/data_flag | 1 | bslbf |
| service_descriptor | 5 | uimsbf |
| if (audio/data_flag==0) { | | |
| audio_config | 16 | uimsbf |
| reserved | 3 | ‘111’ |
| } | | |
| else { | | |
| app_id | 16 | uimsbf |
| app_domain | 3 | uimsbf |
| } | | |
| language_short | 4 | uimsbf |
| language-country_flag | 1 | Bslbf |
| if (language-country_flag==1) { | | |
| language_long | 24 | bslbf |
| country_of_origin | 16 | bslbf |
| } | | |
| if (servicegrouping_use_flag == 1) { | | |
| num_servicegrouping_references | 8 | uimsbf |
| for (k=0; k< num_servicegrouping_references; k++) { | | |
| category_id | 5 | uimsbf |
| property_id | 11 | uimsbf |
| } | | |
| } | | |
| service_logo_flag | 1 | bslbf |
| service_extension_flag | 1 | bslbf |
| service_label_size_minus1 | 6 | uimsbf |
| service_label | 8 × (size) | bslbf |
| if (service_logo_flag==1) { | | |
| logo_id | 16 | uimsbf |
| if (single_logo_substream_flag == 0) { | | |
| reserved | 2 | ‘11’ |
| logo_plp_id | 6 | uimsbf |
| } | | |
| } | | |
| if (service_extension_flag==1) { | | |
| service_extension_size_minus1 | 8 | uimsbf |
| service_extension | 8 × (size) | bslbf |
| } | | |
| } | | |
| } | 8 | uimsbf |
| Fragment Extension Section: | | |
| if (fragment_extension_flag==1) { | | |
| fragment_extension_size_minus1 | 8 | uimsbf |
| fragment_extension | 8 × (size) | bslbf |
| } | | |
| End of LMT-R Fragment “Body Section”: | | |
| fragment_crc | 16 | uimsbf |
| } | | |

Imt-r_version—the version of the Link Mapping Table protocol for DRM-Radio in use. For DRM-Radio Link Mapping Table Fragments constructed according to the provisions of the current document, its value shall be ‘0’. If other Imt-r_version values than ‘0’ are not understood by entities processing LMT-R Fragments, such LMT-R Fragments indicating non-understood Imt-r_version values other than ‘0’ shall be ignored.

drm_ewf_active_flag—when set to ‘1’ shall indicate that DRM Emergency Warning Functionality is active for at least one DRM-Radio Service in the ATSC 3.0 transmission.

Imt-r_data_revision—shall indicate the current revision number of the LMT-R table. Its value shall be carried identically by all LMT-R Fragments carried in the ATSC transmission. Whenever the fragment_data_revision parameter value changes in at least one LMT-R Fragment representing the LMT-R table, or if the overall number of LMT-R Fragments indicated by the num_fragments_minus1 parameter changes, the value of Imt-r_data_revision shall increment by one for all LMT-R Fragments, rolling over from a value of ‘15’ to a value of ‘0’. If needed, changes to the LMT-R table shall be delayed so that the occurrence of each value of Imt-r_data_revision remains stable for at least 5 seconds.

num_fragments_minus1—shall have a value one less than the total number of LMT-R Fragments comprising the entire LMT-R table with the same Imt-r_version value. It shall have a range from 0 to 2047 decimal, corresponding to 1 to 2048 LMT-R Fragments.

fragment_index—shall indicate the unique index value of the current LMT-R Fragment within the sequence of LMT-R Fragments representing the full LMT-R table. The LMT-R table shall be composed of exactly one Fragment for every value of fragment_index from 0 to num_fragments_minus1.

fragment_data_revision—shall indicate the current revision of the data carried in this LMT-R Fragment. Whenever any data carried in this Fragment between the ‘Start of LMT-R Fragment “Payload Section”’ marker and the ‘End of LMT-R Fragment “Body Section”’ marker changes, the value of its fragment_data_revision shall increment by one, rolling over from a value of ‘15’ to a value of ‘0’.

fragment_extension_flag—when set to ‘1’ shall indicate that the fragment_extension_size_minus1 and fragment_extension fields are present in this LMT-R Fragment. Otherwise, its value shall be set to ‘0’.

fragment_compression_flag—when set to a value of ‘1’ shall indicate that the Fragment in which it is carried is compressed, starting from the “Start of LMT-R fragment ‘Body Section’” marker to the “End of LMT-R fragment ‘Body Section’” marker, using gzip [8]; otherwise it shall indicate that the Fragment is uncompressed. Compression shall only be applied if the result is a decrease in the size of the Fragment, and should be applied in those cases.

revision_table_use_flag—when set to a value of ‘1’ shall indicate that this LMT-R Fragment carries a revision table. The revision table simplifies change management of the LMT-R. If all LMT-R Fragments are carried within the same PLP, then the use of a revision table is optional. If LMT-R Fragments are carried within multiple PLPs, then at least the LMT-R Fragment with the lowest fragment_index in each PLP shall carry a revision table. The use of a revision table in other LMT-R fragments is optional.

rt_fragment_plp_id—shall be the value that identifies the PLP that carries the LMT-R Fragment. It shall have a range of 0 to 63 decimal.

rt_fragment_data_revision—shall be the value of the fragment_data_revision parameter of the LMT-R Fragment found within the PLP identified by the associated rt_fragment_plp_id value.

rt_byte_alignment—shall be used to ensure byte alignment of the revision table. Byte alignment shall be applied when the revision table has an odd number of (12-bit) entries.

servicegrouping_use_flag—when set to ‘1’ shall indicate that the Service Grouping mechanism (see below) is available for this ATSC transmission and, thus, that for every DRM-Radio Service in this LMT-R Fragment, a list of Service Grouping references may be specified. Such a list comprises 0 to 255 references per DRM-Radio Service as defined by parameter num_servicegrouping_references. If set to ‘0’, DRM-Radio Services specified in this LMT-R Fragment do not make use of the Service Grouping mechanism.

Imt-r-sg_plp_id—shall be the value that identifies the PLP that carries the LMT-R-SG Fragment with the lowest fragment_index value in the ATSC multiplex (typically value ‘0’). It shall have a range of 0 to 63 decimal.

Imt-r-sg_revision—shall indicate the needed revision of the LMT-R-SG table carrying the Service Grouping configuration data as defined by its Imt-r-sg_data_revision parameter value. Only while this value is equal to the revision value used within the LMT-R-SG are the Service Grouping references within this LMT-R Fragment valid, and only then shall they be processed. It shall have a range of 0 to 255 decimal.

single_logo_substream_flag—when set to a value of ‘1’ shall indicate that all LIT Fragments describing the Logo references (by MDI Streams or DRM Services) within this LMT-R Fragment are carried in the same, single PLP. A value of ‘0’ shall indicate that that an individual PLP is specified for every LIT Fragment describing a Logo referenced in this LMT-R Fragment, or that no Logos are referenced within this LMT-R Fragment.

single_logo_plp_id—shall be the value that identifies the PLP that carries the LIT Fragments describing all the Logo definitions referenced within this LMT-R Fragment. It shall have a range of 0 to 63 decimal.

num_mdi_streams_minus1—shall have a value one less than the number of MDI Streams described in the LMT-R table Fragment in which it is carried. It shall have a range from 0 to 255 decimal.

mux_label_flag—when set to ‘1’ shall indicate that a multiplex label is provided for the MDI Stream with which it is associated. Otherwise, its value shall be set to ‘1’.

mux_logo_flag—when set to ‘1’ shall indicate that a multiplex Logo is provided for the MDI Stream with which it is associated. Otherwise, its value shall be set to ‘0’.

mux_plp_id—shall be the value that identifies the PLP that carries the content of the MDI Stream with which it is associated. It shall have a range of 0 to 63 decimal.

mux_alp_sid—shall be the value that identifies the Sub-stream within the ALP packet Stream that carries the content of the MDI Stream with which it is associated. It shall have a range of 0 to 255 decimal.mux_label_size_minus1—shall be present when the mux_label_flag is set to ‘1’ and shall indicate the number of octets, minus 1, carried in the mux_label field. The number of octets can range from 1 to 64 decimal, which values shall be represented by numbers from 0 to 63, respectively.

mux_label—shall be present when the multiplex_label_flag is set to ‘1’ and shall represent a text label for the DRM Multiplex (MDI Stream) with which it is associated. It shall comprise a string of UTF-8 octets, up to 64 of which can be sent to produce a maximum of 32 displayable characters, according to ISO/IEC 10646 [9]. See DRM System Specification [4] Section 6.7 Presentation of service labels and text messages.

logo_id—shall be the numeric identifier from 1 to 65535 decimal that uniquely identifies a Logo to visually represent the Multiplex or Service entity with which it is associated, from the set of available broadcast Logos. The value 0 may indicate ‘no Logo/Icon’ and shall not be assigned to an actual Logo/Icon.

logo_plp_id—shall be present when the single_logo_substream_flag is set to ‘1’ and shall be the value that identifies the PLP that carries the LIT Fragment describing the Logo with which it is associated. It shall have a range of 0 to 63 decimal.

num_services_minus1—shall have a value one less than the number of Services carried in the DRM-Radio Multiplex (i.e. MDI Stream) with which the value is associated. It shall have a range from 0 to 3.

service_id—shall be the identifier defined in the DRM System Specification [4] Section 6.3.4 Service Parameters and Annex T.

ca_flag_audio—shall be set to ‘1’ to indicate that Conditional Access is applied to audio carried at the Service ID with which it is associated. A value of ‘0’ shall indicate that CA is not applied to the audio at that Service ID. See DRM System Specification [4] Section 6.3.4 Service Parameters.

ca_flag_data—shall be set to ‘1’ to indicate that Conditional Access is applied to data carried at the Service ID with which it is associated. A value of ‘0’ shall indicate that CA is not applied to the data at that Service ID. See DRM System Specification [4] Section 6.3.4 Service Parameters.

audio/data_flag—shall be set to ‘0’ to indicate that the associated Service is audio and shall be set to ‘1’ to indicate that the associated service is data. See DRM System Specification [4] Section 6.3.4 Service Parameters.

service_descriptor—shall indicate the audio service type or data application identifier as defind in the DRM System Specification [4] Section 6.3.4 Service Parameters, Table 19 Programme Type Codes.

audio_config—shall contain the Audio Information Data specified in the DRM System Specification [4] Section 6.4.3.10 Audio Information Data Entity-Type 9, in the order and field sizes and according to the definitions presented therein, with the exceptions of the Short ID and Stream ID at the beginning and of the Codec Specific Config at the end, which shall be omitted.

app_id—shall indicate the application identifier of a data service as defined in the DRM Data Application Directory [6].

app_domain—shall indicate the application domain of a data service as defined in the DRM Data Application Directory [6] Section 4.3.1 Application Domain, Table 2 Application Domains.

language_short—shall indicate the language of the target audience as defined in the DRM System Specification [4] Section 6.3.4 Service Parameters, Table 18 Language Codes.

language-country_flag—when set to ‘1’ shall indicate the presence of the language_long and country_of_origin fields. Otherwise its value shall be set to ‘0’.

language_long—shall indicate the language of the target audience of the service according to DRM System Specification [4] Section 6.4.3.13 Language and Country Data Entity-Type 12, provisions for language_code.

country_of_origin—shall indicate the country of origin of the service (the site of the studio) according to DRM System Specification [4] Section 6.4.3.13 of [1], Language and Country Data Entity-Type 12 provisions for country_code.

num_servicegrouping_references—shall indicate as part of an enabled Service Grouping mechanism (i.e., when servicegrouping_use_flag is set to ‘1’) the number of references to Category/Property combinations to which the DRM-Radio Service with which the values are associated belongs. It shall have a range from 0 to 255. While the DRM-Radio Service can be associated with multiple Properties belonging to the same Category, each combination of Category ID and Property ID in the list shall be unique.

category_id—shall carry the ID value identifying the Category of the current Service Grouping reference. The available Category IDs are signalled in the Service Grouping LMT-R-SG table (see below).

property_id—shall carry the ID value identifying the Property of the current Service Grouping reference within the Category specified by the category_id value. The available Property IDs per Category are signalled in the Service Grouping LMT-R-SG table (see below).

service_logo_flag—when set to ‘1’ shall indicate that a service Logo is provided for the DRM-Radio Service with which it is associated. Otherwise, its value shall be set to ‘0’. See above in the semantics section for Table 7.7 for a description of the logo-related parameters logo_id, logo_plp_id and logo_alp_sid.

service_extension_flag—when set to ‘1’ shall indicate that a service_extension field associated with the Service is carried within the LMT-R Fragment within which it is found; otherwise, it shall be set to ‘0’.

service_label_size_minus1—shall indicate the number of octets, minus 1, carried in the service_label field. The number of octets can range from 1 to 64 decimal, which value shall be represented by numbers from 0 to 63, respectively.

service_label—shall represent a text label for the Service with which it is associated. It shall be a string of UTF-8 octets, up to 64 of which can be sent to produce a maximum of 32 displayable characters, according to ISO/IEC 10646. [9] See DRM System Specification [4] Section 6.7 Presentation of service labels and text messages.

service_extension_size_minus1—shall indicate the number of bytes included in the associated service_extension field, with values from 0 to 255 decimal corresponding to a service_extension field carrying from 1 to 256 bytes, respectively.

service_extension—shall be a field carrying one more than the number of bytes of data indicated in the service_extension_size_minus1 field and related to the Service with which it is associated. The content of this field is intended for future definition and shall be ignored by decoders that do not know how to interpret it.

fragment_extension_size_minus1—shall indicate the number of bytes included in the associated fragment_extension field, with values from 0 to 255 decimal corresponding to a fragment_extension field carrying from 1 to 256 bytes, respectively.

fragment_extension—shall be a field carrying one more than the number of bytes of data indicated in the fragment_extension_size_minus1 field and related to the LMT-R Fragment in which it is found. The content of this field is intended for future definition and shall be ignored by decoders that do not know how to interpret it.

fragment_crc—shall be a 16-bit Cyclic Redundancy Check (CRC-16) value calculated according to [7], with its value calculated using as input the full content of the LMT-R Fragment in which it is found, i.e. the block of data including the field values from Imt-r_version through just before fragment_crc.

In the following, Link Mapping Table for DRM-Radio Service Grouping (LMT-R-SG) according to some embodiments is described.

Described is the general LMT format for carriage of configuration data enabling the Service Grouping mechanism for DRM-Radio services, denoted as LMT-R-SG. The general LMT format for IP-based Services is defined in clause 7.1.1, and the general LMT format for DCP-based DRM-Radio services is defined in clause 7.1.3.

The Service Grouping mechanism allows a user to conveniently discover, find, and select services from a potentially long list of DRM-Radio services based on Categories and Properties.

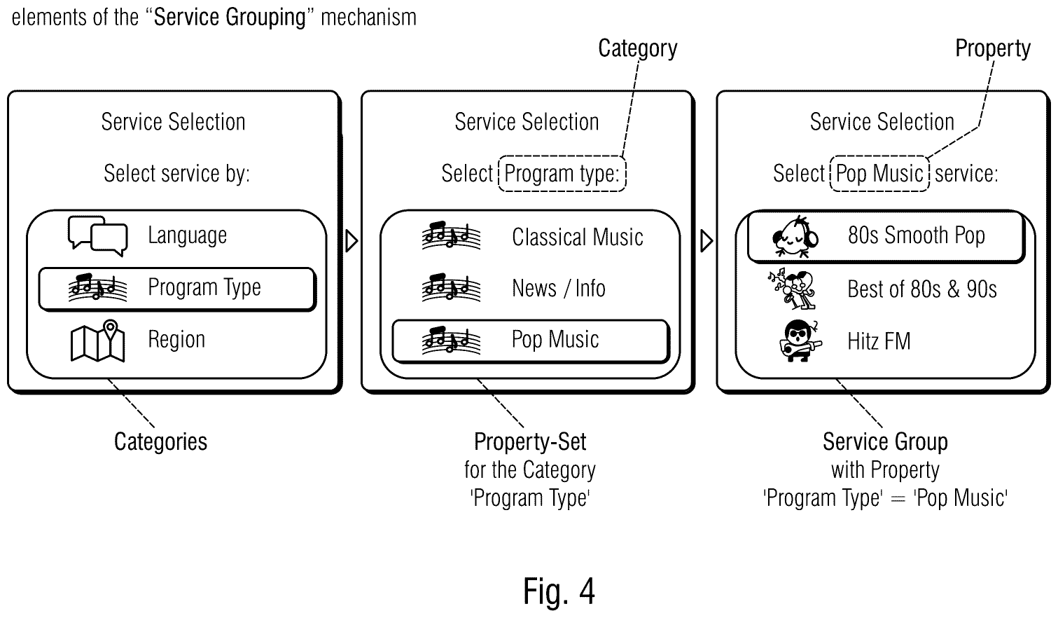

The configuration data carried in the LMT-R-SG enables the Service Grouping mechanism for DRM-Radio Services by defining which Categories and which Properties per Category are available in the current ATSC multiplex. Categories allow grouping services based on various independent characteristics. Examples of categories are language, broadcast network, data application type, program type, region, country of origin, target audience age group, and so on. The Properties (i.e. options) from which a user can choose within a given Category, such as the languages available for selection in the ‘Language’ category, collectively are called the Property-Set of that specific Category. The resulting collection of all DRM-Radio Services sharing the same Property value for a given Category (e.g., all ‘English’ services in the ‘Language’ Category) are referenced as a Service Group. FIG. 4 showcases the components of the Service Grouping mechanism.

In particular, FIG. 4 depicts components of the Service Group mechanism: Categories and Properties.

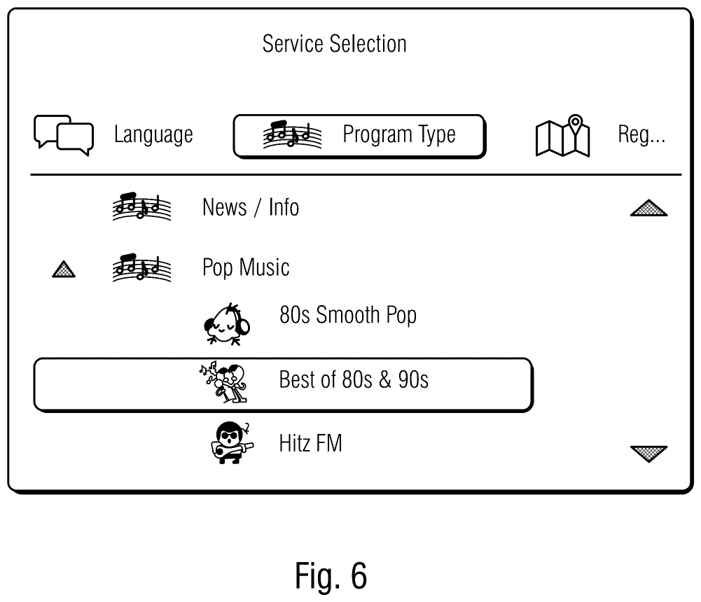

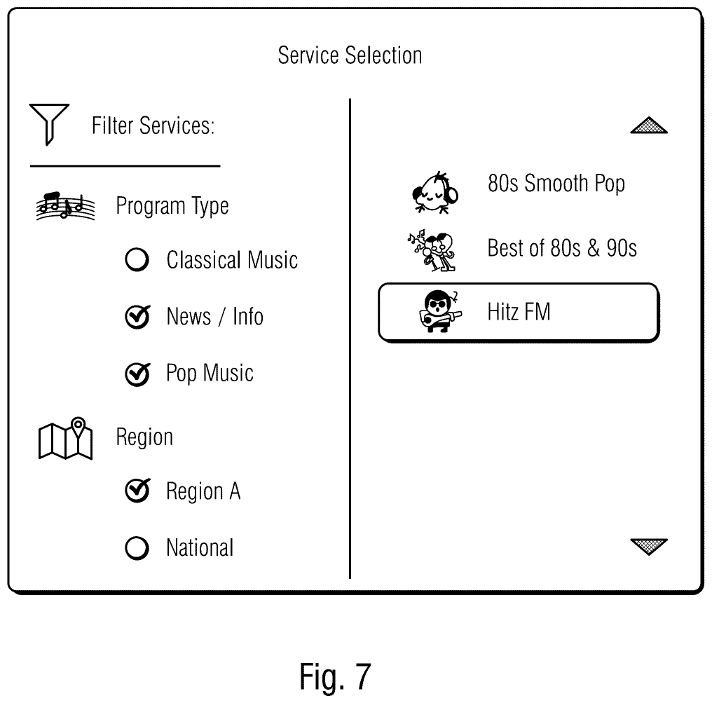

The Service Grouping mechanism allows a receiver to present, in a more structured and convenient form for a user, a list of available DRM-Radio Services, which, by default, may simply be an alphabetically sorted list, for a quicker and more precise identification and selection of relevant Services. The metadata provided through the Service Grouping mechanism allows a receiver to group and/or filter Services. Simple receivers or receivers with small screens may present the Categories available, followed by the Property-Set available for a selected Category, followed by the Service Group resulting from a user-selected Property, with each step on an individual screen (see FIG. 5). More advanced receivers with larger screen spaces may present combined views to users that keep all Services available for selection at all times but visually group the Services with Properties as in-between headlines (see FIG. 6). Finally, receivers may implement filtering mechanisms based on Service Grouping information, allowing users to combine one or more Parameters across multiple Categories to quickly condense the resulting Service lists to the Services that simultaneously fulfill all the user-selected criteria. For the latter use-case, the selection of multiple Properties from a Property-Set should be treated as an ‘or’-combination, while different Categories with activated Properties should be considered ‘and’-combinations. With this approach, the resulting Service list will contain only services that comply with at least one selected Property from every active Category (see FIG. 7).

In particular, FIG. 5 depicts a Service Grouping mechanism, in particular, an example of service grouping through a multi-screen sequence.

FIG. 6 depicts a Service Grouping mechanism: Example of single-screen service grouping through in-between Property headlines.

FIG. 7 depicts a Service Grouping mechanism: Example of service filtering.

Each DRM-Radio Service, as part of the Service description carried in the LMT-R information, can declare itself as possessing one or more Properties from one or multiple of the available Categories (or might not make use of the Service Grouping mechanism at all).

In the case of DRM-Radio Service grouping, DRM-Radio Services that do not carry Service Grouping references of a given Category still should be listed/made available, e.g., as a member of a catch-all ‘Undefined/Other’ Service Group. In the case of DRM-Radio Service filtering, however, those DRM-Radio Services should be hidden if any Property of the specific Category is selected by the user.

A DRM-Radio Service declares itself as possessing Properties for one or more Service Grouping Categories through a list of Service Grouping references, with every reference consisting of the numeric ID of a Category followed by the numeric ID of a Property within this Category (see below). Only numeric ID values for Categories and Properties defined in the LMT-R-SG table for the current ATSC transmission can be used.

When changes are applied to the Service Grouping configuration (LMT-R-SG), consistency of Service Grouping references is maintained through application of a revision number: i.e., Service Grouping references contained in the LMT-R table can only be resolved by a receiver using the LMT-R-SG table having the same indicated revision number.

There shall be only a single LMT-R-SG table per ATSC transmission; that table, however, may be carried in multiple Fragments. The LMT-R-SG table shall contain and define all Categories and Properties per Category used across all DRM-Radio Services of that ATSC transmission. The Service Grouping references carried in the DRM-Radio LMT-R can only reference those Category and Property values currently defined in the LMT-R-SG table. Categories and Properties no longer referenced by any DRM-Radio Service shall be removed from the LMT-R-SG table, so that a receiver can derive the list of currently used and actually populated Categories and Properties from the LMT-R-SG table alone.

In addition to the numerical identifiers for the various Categories and Properties per Category, the LMT-R-SG table also carries Labels for each of the two characteristics and may carry Logo references related to each of the two characteristics. The Labels and Logo references provide receivers with the raw materials they need to create Service guides and selection systems ranging from the simplest, character-based schemes to the most sophisticated, graphics-oriented navigation systems. Labels for all Categories and their associated Properties are mandatory, while Logo references for Categories and Properties are optional.

The Categories and Properties are coded into binary enumerations in 5 bits and 11 bits, respectively, collectively called Service Grouping references. Thus, there can be up to 32 different Categories defined at any time and up to 2048 different Properties within each Category. The numeric ID values for Properties can be freely assigned (as long as every Property ID value is only defined once within a Category). If Properties of a Category are listed, they shall be sorted in ascending order of the numeric Property ID values (even if the Properties within a Category are split across multiple LMT-R-SG Fragments). For Categories, the numeric ID values 0 to 15 are reserved for standardized, pre-defined Category types, while the numeric ID values 16 to 31 can be freely assigned to additional Category types (as long as every Category ID value is only defined once in the LMT-R-SG table). The pre-defined Category ID values are defined in Table 7.8; they cover the most common Category types and allow a receiver to easily use localized Labels or preinstalled Icons. A reference decoder not knowing or caring about the special meaning of pre-defined Category ID values is expected to treat them just like any freely assigned Category ID values.

TABLE 7.8
Service Grouping mechanism-Category ID values

| Category ID value | Category type |
|---|---|
| 0 | Language |
| 1 | Program type |
| 2 | Data application type |
| 3 | Region |
| 4 | Country of origin |
| 5 | Target audience age group |
| 6 | Broadcast network |
| 7 . . . 15 | reserved for future definition |
| 16 . . . 31 | available for free assignment per ATSC |
| | transmission |

Provision is made in the LMT-R-SG table structure for inclusion of textual Labels for presentation within Service guides and for other uses derived from information carried in LMT-R-SG Fragments. Such Labels shall be included to let users identify specific Categories and Properties. The same encoding and rules defined for Labels carried in LMT-R Fragments shall apply to Labels carried in LMT-R-SG Fragments (see section 7.1.3).

Fragments may be composed in two ways with respect to which of three information components of the overall LMT-R-SG table they carry. The three information components are (1) the available Categories, identified by the numeric Category IDs, the Label data for the Categories, and the Category Logos, if any; (2) the available Properties per Category, identified under the related Category IDs by numeric Property IDs, the Label data for the Properties, and the Property Logos, if any; and (3) an optional Fragment Extension, if any. Every LMT-R-SG Fragment shall begin with a Fragment Management section and end with a Fragment CRC. Between the Fragment Management sections and the Fragment CRCs, Fragments may include Category definitions (1) followed by related Property definitions (2) and an optional Fragment Extension (3), or they may include only Property definitions (2) and an optional Fragment Extension (3).

Each Category shall be defined exactly once in a Category definition section (1) and each Property shall be defined exactly once in a Property definition section (2) related to a single Category within the LMT-R-SG table.

LMT-R-SG table Fragments shall not be segmented or concatenated and shall be limited to 65,535 bytes of payload prior to application of any compression. Thus, in the headers of ALP packets carrying LMT-R-SG Fragments, PC shall be set to ‘0’ and HM shall be set to ‘1’, meaning that the Additional Header for Single Packets shall be applied to each ALP packet carrying an LMT-R-SG Fragment. The body sections of LMT-R-SG Fragments should be compressed using gzip [8], however compression shall be applied to an LMT-R-SG Fragment only if doing so results in overall reduction of the size of the Fragment.

All Fragments constituting the complete LMT-R-SG table should be repeated at least once every second; but in any case, they shall be repeated at a rate of at least once every 5 seconds. When present, the LMT-R-SG should be broadcast at the same rate as the SLT. At least the LMT-R-SG Fragment with lowest index value carried in a given PLP shall carry a table indicating the locations and revision statuses of all Fragments, including those carried outside the current PLP.

When carrying an LMT-R-SG Fragment, an ALP packet's Base Header packet_type value shall be ‘100’ (Link layer signaling packet). Only ALP single-packet headers shall be applied to packets carrying LMT-R-SG Fragments. The values for the Additional Headers of ALP packets carrying LMT-R-SG Fragments, which are defined in Table 5.11, shall be as given in Table 7.9. The syntax of an LMT-R-SG Fragment itself shall be as given in Table 7.10, and semantics of an LMT-R-SG Fragment shall be as described in the text section following Table 7.10.

TABLE 7.9
ALP Packet Additional Header Values for LMT-R-SG

| Fields in Additional Header for Signaling | No. of bits | Value |
|---|---|---|
| signaling_type | 8 | 0x04 |
| signaling_type_extension | 16 | 0xFFFF |
| signaling_format | 2 | 00 |
| signaling_encoding | 2 | 00 |

TABLE 7.10
Syntax for Link Mapping Table for DRM-Radio Service
Grouping (LMT-R-SG) Fragments

| Syntax | No. of bits | Format |
|---|---|---|
| link_mapping_table_fragment_lmt-r-sg( ) { | | |
| Fragment Management Section: | | |
| lmt-r-sg_version | 2 | uimsbf |
| reserved | 2 | ‘11’ |
| lmt-r-sg_data_revision | 4 | uimsbf |
| num_ fragments_minus1 | 11 | uimsbf |
| fragment_index | 11 | uimsbf |
| fragment_data_revision | 4 | uimsbf |
| fragment_extension_flag | 1 | bslbf |
| fragment_compression_flag | 1 | bslbf |
| revision_table_use_flag | 1 | bslbf |
| reserved | 3 | ‘111’ |
| Start of LMT-R-SG Fragment “Body Section”: | | |
| if (revision_table_use_flag==1) { | | |
| for (i = 0; i <= num_fragments_minus1; ++i) { | | |
| reserved | 2 | ‘11’ |
| rt_fragment_plp_id | 6 | uimsbf |
| rt_fragment_data_revision | 4 | uimsbf |
| } | | |
| if (is_even_number(num_fragments_minus1)) { | | |
| rt_byte_alignment | 4 | ‘1111’ |
| } | | |
| } | | |
| Start of LMT-R-SG Fragment “Payload Section”: | | |
| single_logo_substream_flag | 1 | bslbf |
| reserved | 1 | ‘1’ |
| if (single_logo_substream_flag == 1) { | | |
| single_logo_plp_id | 6 | uimsbf |
| } else { | | |
| reserved | 6 | ‘111111’ |
| } | | |
| Category definitions: | | |
| category_definition_flag | 1 | bslbf |
| if (category_definition_flag ==1) { | | |
| num_categories_minus1 | 5 | uimsbf |
| reserved | 2 | ‘11’ |
| for (i=0; i <=num_categories_minus1; i++) { | | |
| category_id | 5 | Uimsbf |
| category_logo_flag | 1 | bslbf |
| category_label_size_minus1 | 6 | uimsbf |
| reserved | 4 | ‘1111’ |
| category_label | 8 × (size) | bslbf |
| if (category_logo_flag ==1) { | | |
| logo_id | 16 | uimsbf |
| if (single_logo_substream_flag == 0) { | | |
| reserved | 2 | ‘11’ |
| logo_plp_id | 6 | uimsbf |
| } | | |
| } | | |
| } | | |
| } | | |
| else { | | |
| reserved | 7 | ‘1111111’ |
| } | | |
| Property Definition Section: | | |
| num_category_refs_minus1 | 5 | Uimsbf |
| reserved | 3 | ‘111’ |
| for (k=0; k <=num_category_refs_minus1; k++) { | | |
| category_ref | 5 | uimsbf |
| num_properties_minus1 | 11 | uimsbf |
| for (j=0; j <=num_properties_minus1; j++) { | | |
| property_id | 11 | uimsbf |
| reserved | 6 | ‘111111’ |
| property_logo_flag | 1 | blsbf |
| property_label_size_minus1 | 6 | uimsbf |
| property_label | 8*(size) | bslbf |
| if_property_logo_flag==1 { | | |
| logo_id | 16 | uimsbf |
| if (single_logo_substream_flag == 0) { | | |
| reserved | 2 | ‘11’ |
| logo_plp_id | 6 | uimsbf |
| } | | |
| } | | |
| } | | |
| } | | |
| Fragment Extension Section: | | |
| if (fragment_extension_flag==1) { | | |
| fragment_extension_size_minus1 | 8 | uimsbf |
| fragment_extension | 8*(size) | bslbf |
| } | | |
| End of LMT-R-SG Fragment “Body Section”: | | |
| fragment_crc | 16 | uimsbf |
| } | | |

Imt-r-sg_version—the version of the Link Mapping Table protocol for DRM-Radio Service Group mechanism in use. For DRM-Radio LMT-R-SG Fragments constructed according to the provisions of the current document, its value shall be ‘0’. If other Imt-r-sg_version values than ‘0’ are not understood by entities processing LMT-R-SG Fragments, such LMT-R-SG Fragments indicating non-understood Imt-r-sg_version values other than ‘0’ shall be ignored.

Imt-r-sg_data_revision—shall indicate the current revision number of the LMT-R-SG table. The format and description shall be equivalent to the Imt-r_data_revision parameter above.

num_fragments_minus1—for the parameter format and description see above.

fragment_index—for the parameter format and description see above.

fragment_data_revision—for the parameter format and description see above.

fragment_extension_flag—for the parameter format and description see above.

fragment_compression_flag—for the parameter format and description see above.

revision_table_use_flag—when set to a value of ‘1’ shall indicate that this LMT-R-SG Fragment carries a revision table. The revision table simplifies change management of the LMT-R-SG. If all LMT-R-SG Fragments are carried within the same PLP, then the use of a revision table is optional. If LMT-R-SG Fragments are carried within multiple PLP, then at least the LMT-R-SG Fragment with the lowest fragment_index in each PLP shall carry a revision table. The use of a revision table in other LMT-R-SG Fragments is optional.

rt_fragment_plp_id—shall be the value that identifies the PLP that carries the LMT-R-SG Fragment. It shall have a range of 0 to 63 decimal.

rt_fragment_data_revision—shall be the value of the fragment_data_revision parameter of the LMT-R-SG Fragment.

rt_byte_alignment—shall be used to ensure byte alignment of the revision table. Byte alignment is needed if the revision table has an odd number of (12-bit) entries.

single_logo_substream_flag—for the parameter format and description see above.

single_logo_plp_id—for the parameter format and description see above.

category_definition_flag—when set to ‘1’ shall indicate that at least one Category definition is contained in this LMT-R-SG Fragment. Otherwise, its value shall be set to ‘0’.

num_categories_minus1—shall have a value 1 less than the number of Category definitions described in the LMT-R-SG Fragment in which it is carried. It shall have a range from 0 to 31 decimal.

category_id—shall be the Category ID value of the Category that is being defined. It shall have a range from 0 to 31 decimal.

category_logo_flag—when set to a value of ‘1’ shall indicate that a Category logo is provided. Otherwise its value shall be set to ‘0’.

category_label_size_minus1—the format and description shall be equivalent to the mux_label_size_minus1 parameter above.

category_label—the format and description shall be equivalent to the mux_label parameter above.

logo_id—for the parameter format and description see above.

logo_plp_id—for the parameter format and description see above.

num_category_refs_minus1—shall have a value 1 less than the number of individual Categories for which any Properties will be defined in the LMT-R-SG Fragment in which it is carried. It shall have a range from 0 to 31 decimal.

category_ref—the Category ID value as defined in a Category Reference section of the Category reference to which Properties belong that will be defined in this section. It shall have a range from 0 to 31 decimal.

num_properties_minus1—shall have a value 1 less than the number of Property definitions belonging to the associated Category ID and described in the LMT-R-SG Fragment in which it is carried. It shall have a range from 0 to 31 decimal.

property_id—shall be the Property ID value of the Property that belongs to the Category defined by the associated category_ref value and that shall be defined in this section. It shall have a range from 0 to 2047 decimal.

property_logo_flag—when set to a value of ‘1’ shall indicate that a Property logo is provided. Otherwise its value shall be set to ‘0’.

property_label_size_minus1—the format and description shall be equivalent to the mux_label_size_minus1 parameter above.

property_label—the format and description shall be equivalent to the mux_label parameter above.

logo_id—for the parameter format and description see above.

logo_plp_id—for the parameter format and description see above.

fragment_extension_size_minus1—for the parameter format and description see above.

fragment_extension—for the parameter format and description see above.

fragment_crc—for the parameter format and description see above.

Although some aspects have been described in the context of an apparatus, it is clear that these aspects also represent a description of the corresponding method, where a block or device corresponds to a method step or a feature of a method step. Analogously, aspects described in the context of a method step also represent a description of a corresponding block or item or feature of a corresponding apparatus. Some or all of the method steps may be executed by (or using) a hardware apparatus, like for example, a microprocessor, a programmable computer or an electronic circuit. In some embodiments, one or more of the most important method steps may be executed by such an apparatus.

Depending on certain implementation requirements, embodiments of the invention can be implemented in hardware or in software or at least partially in hardware or at least partially in software. The implementation can be performed using a digital storage medium, for example a floppy disk, a DVD, a Blu-Ray, a CD, a ROM, a PROM, an EPROM, an EEPROM or a FLASH memory, having electronically readable control signals stored thereon, which cooperate (or are capable of cooperating) with a programmable computer system such that the respective method is performed. Therefore, the digital storage medium may be computer readable.

Some embodiments according to the invention comprise a data carrier having electronically readable control signals, which are capable of cooperating with a programmable computer system, such that one of the methods described herein is performed.

Generally, embodiments of the present invention can be implemented as a computer program product with a program code, the program code being operative for performing one of the methods when the computer program product runs on a computer. The program code may for example be stored on a machine readable carrier.

Other embodiments comprise the computer program for performing one of the methods described herein, stored on a machine readable carrier.

In other words, an embodiment of the inventive method is, therefore, a computer program having a program code for performing one of the methods described herein, when the computer program runs on a computer.

A further embodiment of the inventive methods is, therefore, a data carrier (or a digital storage medium, or a computer-readable medium) comprising, recorded thereon, the computer program for performing one of the methods described herein. The data carrier, the digital storage medium or the recorded medium are typically tangible and/or non-transitory.

A further embodiment of the inventive method is, therefore, a data stream or a sequence of signals representing the computer program for performing one of the methods described herein. The data stream or the sequence of signals may for example be configured to be transferred via a data communication connection, for example via the Internet.

A further embodiment comprises a processing means, for example a computer, or a programmable logic device, configured to or adapted to perform one of the methods described herein.

A further embodiment comprises a computer having installed thereon the computer program for performing one of the methods described herein.

A further embodiment according to the invention comprises an apparatus or a system configured to transfer (for example, electronically or optically) a computer program for performing one of the methods described herein to a receiver. The receiver may, for example, be a computer, a mobile device, a memory device or the like. The apparatus or system may, for example, comprise a file server for transferring the computer program to the receiver.

In some embodiments, a programmable logic device (for example a field programmable gate array) may be used to perform some or all of the functionalities of the methods described herein. In some embodiments, a field programmable gate array may cooperate with a microprocessor in order to perform one of the methods described herein. Generally, the methods are performed by any hardware apparatus.

The apparatus described herein may be implemented using a hardware apparatus, or using a computer, or using a combination of a hardware apparatus and a computer.

The methods described herein may be performed using a hardware apparatus, or using a computer, or using a combination of a hardware apparatus and a computer.

While this invention has been described in terms of several advantageous embodiments, there are alterations, permutations, and equivalents, which fall within the scope of this invention. It should also be noted that there are many alternative ways of implementing the methods and compositions of the present invention. It is therefore intended that the following appended claims be interpreted as including all such alterations, permutations, and equivalents as fall within the true spirit and scope of the present invention.

### REFERENCES

[1] “ATSC Standard: Link-Layer Protocol (A/330)”, 2022-03, published 31 Mar. 2022.
[2] ATSC: “ATSC Standard: Physical Layer Protocol,” Doc. A/322:2017, Advanced Television Systems Committee, Washington, D.C., 6 Jun. 2017.
[3] ETSI: TS 102 821, “Digital Radio Mondiale (DRM); Distribution and Communications Protocol (DCP),” V1.4.1 (2012-10), European Telecommunications Standards Institute, Valbonne-Sophia Antipolis France, October 2012.
[4] ETSI: ES 201 980, “Digital Radio Mondiale (DRM); System Specification,” V4.2.1 (2020-11), European Telecommunications Standards Institute, Valbonne-Sophia Antipolis France, November 2020.
[5] ETSI: TS 102 820, “Digital Radio Mondiale (DRM); Multiplex Distribution Interface (MDI),” V4.1.1 (2016-03), European Telecommunications Standards Institute, Valbonne-Sophia Antipolis France, March 2016.
[6] ETSI: TS 101 968, “Digital Radio Mondiale (DRM) Data Application Directory,” European Telecommunications Standards Insititute, Valbonne-Sophia Antipolis France, November 2020.
[7] ITU-T, “V.41 Data Communication Over the Telephone Network, Code-Independent Error-Control System,” 1993.
[8] IETF: “DEFLATE Compressed Data Format Specification, version 1.3”, Internet Engineering Task Force, Reston, VA, May 1996, http://tools.ietf.org/html/rfc1951.
[9] ISO/IEC: 10646, “Information Technology-Universal Coded Character Set (UCS)” International Organization for Standardization/International Electrotechnical Commission, Geneva, Switzerland, December 2020.
[10] EP 1658689 A1, “Radio comprising a Display for Text Information referring to other Text Information Objects”.
[11] ETSI: TS 103 771, “Digital Radio Mondiale (DRM); Regional profiles,” V1.1.1 (2020-11, European Telecommunications Standards Institute, Valbonne-Sophia Antipolis France, November 2020.

1. An apparatus for decoding, comprising:
an interface for receiving a plurality of ATSC Link-layer Protocol packets each of which comprising a packet header and a packet payload encapsulating digital content, and
a decoding unit,
wherein the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content, and
wherein the decoding unit is configured to decode the packet payload of each one of at least one ATSC Link-layer Protocol packet of the one or more ATSC Link-layer Protocol packets to acquire the digital content of said one of the at least one ATSC Link-layer Protocol packet.

2. An apparatus according to claim 1,
wherein the digital content being encapsulated within the packet payload of an ATSC Link-layer Protocol packet of the one or more ATSC Link-layer Protocol packets comprises digital radio content, and
wherein the decoding unit is configured to decode the packet payload of said ATSC Link-layer Protocol packet to acquire the digital radio content being encapsulated within the packet payload of said ATSC Link-layer Protocol packet.

3. An apparatus according to claim 1,
wherein the digital content being encapsulated within the packet payload of an ATSC Link-layer Protocol packet of the one or more ATSC Link-layer Protocol packets comprises a Distribution and Communications Protocol packet or a portion thereof, and
wherein the decoding unit is configured to decode the packet payload of said ATSC Link-layer Protocol packet to acquire the Distribution and Communications Protocol packet or the portion thereof being encapsulated within the packet payload of said ATSC Link-layer Protocol packet.

4. An apparatus according to claim 3,
wherein the Distribution and Communications Protocol packet or the portion thereof being encapsulated within the packet payload of said ATSC Link-layer Protocol packet comprises digital radio content,
wherein the decoding unit is configured to decode the packet payload of said ATSC Link-layer Protocol packet to acquire the digital radio content being comprised by the Distribution and Communications Protocol packet or the portion thereof being encapsulated within the packet payload of said ATSC Link-layer Protocol packet.

5. An apparatus according to claim 2,
wherein the digital radio content comprises Digital Radio Mondial content.

6. An apparatus according to claim 1,
wherein the digital content being encapsulated within the packet payload of an ATSC Link-layer Protocol packet of the one or more ATSC Link-layer Protocol packets comprises Unified Speech and Audio Coding content or extended High Efficiency Advanced Audio Coding content, and
wherein the decoding unit is configured to decode the packet payload of said ATSC Link-layer Protocol packet to acquire the Unified Speech and Audio Coding content or the extended High Efficiency Advanced Audio Coding content being encapsulated within the packet payload of said ATSC Link-layer Protocol packet.

7. An apparatus according to claim 1,
wherein the digital content being encapsulated within the packet payload of an ATSC Link-layer Protocol packet of the one or more ATSC Link-layer Protocol packets comprises Journaline content, and
wherein the decoding unit is configured to decode the packet payload of said ATSC Link-layer Protocol packet to acquire the Journaline content being encapsulated within the packet payload of said ATSC Link-layer Protocol packet.

8. An apparatus according to claim 1,
wherein the apparatus further comprises a renderer for providing an output, being one or more audio output signals, or being a visual output, or being a data output, depending on the digital content being encapsulated within said ATSC Link-layer Protocol packet.

9. An apparatus according to claim 7,
wherein the apparatus further comprises a renderer for providing an output, being one or more audio output signals, or being a visual output, or being a data output, depending on the digital content being encapsulated within said ATSC Link-layer Protocol packet,
wherein the renderer is configured to provide the output using the Journaline content.

10. An apparatus according to claim 1,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate one or more services of an ATSC transmission,
wherein the decoding unit is configured to identify the ATSC Link-layer Protocol packet which comprises content of one of the one or more services by analyzing the one or more fragments of the Link Mapping Table for services.

11. An apparatus for decoding, comprising:
an interface for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
a decoding unit, wherein the decoding unit is configured to decode the packet payload of each one of at least one ATSC Link-layer Protocol packet of the plurality of ATSC Link-layer Protocol packets to acquire the digital content of said one of the at least one ATSC Link-layer Protocol packet,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate the one or more services of the ATSC transmission,
wherein the decoding unit is configured to identify the ATSC Link-layer Protocol packet which comprises content of one of the one or more services by analyzing the one or more fragments of the Link Mapping Table for services.

12. An apparatus according to claim 11,
wherein the one or more fragments of the Link Mapping Table for services are one or more fragments of a Link Mapping Table for radio services,
wherein the one or more fragments of the Link Mapping Table for radio services indicate one or more radio services of the ATSC transmission,
wherein the decoding unit is configured to identify the ATSC Link-layer Protocol packet which comprises content of one of the one or more radio services by analyzing the one or more fragments of the Link Mapping Table for radio services.

13. An apparatus according to claim 12,
wherein the one or more fragments of the Link Mapping Table for radio services comprise metadata for the one or more radio services of the ATSC transmission.

14. An apparatus according to claim 13,
wherein at least some of the plurality of ATSC Link-layer Protocol packets encapsulate a plurality of Distribution and Communications Protocol packets comprising the one or more radio services of the ATSC transmission.

15. An apparatus according to claim 13,
wherein the metadata for the one or more radio services comprises information on a service label, and/or information on a multiplex label, and/or information on a language, and/or information on a program type, and/or information on a region, and/or information on a country of origin, and/or audio configuration information, and/or a data application identifier.

16. An apparatus according to claim 12,
wherein the one or more fragments of the Link Mapping Table for radio services are one or more fragments of the Link Mapping Table for Digital Radio Mondiale-Radio,
wherein the one or more fragments of the Link Mapping Table for Digital Radio Mondiale-Radio indicate one or more Digital Radio Mondiale radio services of the ATSC transmission,
wherein the decoding unit is configured to identify the ATSC Link-layer Protocol packet which comprises content of one of the one or more Digital Radio Mondiale radio services by analyzing the one or more fragments of the Link Mapping Table for Digital Radio Mondiale-Radio.

17. An apparatus according to claim 16,
wherein the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams, and
wherein the decoding unit is configured to identify the ATSC Link-layer Protocol packet which comprises the Digital Radio Mondiale content depending on the association.

18. An apparatus according to claim 17,
wherein the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

19. An apparatus according to claim 13,
wherein the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams, and
wherein the decoding unit is configured to identify the ATSC Link-layer Protocol packet which comprises the Digital Radio Mondiale content depending on the association,
wherein the metadata for one of the one or more Digital Radio Mondiale radio services corresponds to metadata being comprised by one of the one or more Digital Radio Mondiale Multiplex Distribution Interface streams, which are associated with the one or more Digital Radio Mondiale radio services.

20. An apparatus according to claim 17,
wherein the one or more fragments of the Link Mapping Table for radio services comprise emergency warning information indicating whether or not an emergency warning is indicated by at least one of one or more the Digital Radio Mondiale Multiplex Distribution Interface streams, which are associated with the one or more Digital Radio Mondiale radio services,
wherein the decoding unit is configured to analyse the emergency warning information for determining, whether or not an emergency warning is indicated.

21. An apparatus according to claim 17,
wherein, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets comprises a same sub-stream identifier being associated with the Digital Radio Mondiale Multiplex Distribution Interface stream,
wherein the decoding unit is configured to decode the Digital Radio Mondiale Multiplex Distribution Interface stream, by analysing the sub-stream identifier of the packet header of the two ATSC Link-layer Protocol packets and by decoding the packet payload of the two ATSC Link-layer Protocol packets.

22. An apparatus according to claim 12,
wherein the one or more fragments of the Link Mapping Table for radio services are one or more fragments of the Link Mapping Table for Digital Audio Broadcasting,
wherein the one or more fragments of the Link Mapping Table for Digital Audio Broadcasting indicate one or more Digital Audio Broadcasting services of the ATSC transmission,
wherein the decoding unit is configured to identify the ATSC Link-layer Protocol packet which comprises content of one of the one or more Digital Audio Broadcasting services by analyzing the one or more fragments of the Link Mapping Table for Digital Audio Broadcasting.

23. An apparatus according to claim 22,
wherein the one or more fragments of the Link Mapping Table for Digital Audio Broadcasting indicate an association of at least one of the one or more Digital Audio Broadcasting services with one or more EDI (Encapsulation of DAB Interfaces) streams, and
wherein the decoding unit is configured to identify the ATSC Link-layer Protocol packet which comprises the Digital Audio Broadcasting content depending on the association.

24. An apparatus according to claim 11,
wherein the one or more further ATSC Link-layer Protocol packets are two or more further ATSC Link-layer Protocol packets, wherein the one or more fragments are two or more fragments, wherein the one or more services are a plurality of services,
wherein the two or more further ATSC Link-layer Protocol packets comprise the two or more fragments of the Link Mapping Table for services,
wherein the two or more fragments of the Link Mapping Table for services indicate the plurality of services of the ATSC transmission,
wherein the decoding unit is configured to identify the ATSC Link-layer Protocol packet which comprises the content of one of the one or more services by analyzing the two or more fragments of the Link Mapping Table for services.

25. An apparatus according to claim 1 or 11,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein the apparatus comprises an output interface for providing, depending on at least one of the one or more groupings, an output that depends on at least one of the plurality of services.

26. An apparatus for decoding, comprising:
an interface for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
a decoding unit, wherein the decoding unit is configured to decode the packet payload of each one of at least one ATSC Link-layer Protocol packet of the plurality of ATSC Link-layer Protocol packets to acquire the digital content of said one of the at least one ATSC Link-layer Protocol packet,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein the apparatus comprises an output interface for providing, depending on at least one of the one or more groupings, an output that depends on at least one of the plurality of services.

27. An apparatus according to claim 26,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission,
wherein the output interface is configured to provide, depending on at least one of the one or more groupings, an output that depends on at least one of the plurality of radio services.

28. An apparatus according to claim 27,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission,
wherein the output interface is configured to provide, depending on at least one of the one or more groupings, an output that depends on at least one of the plurality of Digital Radio Mondiale radio services.

29. An apparatus according to claim 27,
wherein the one or more fragments of the Link Mapping Table for Service Grouping are one or more fragments of a Link Mapping Table for Digital Audio Broadcasting Service Grouping,
wherein the one or more fragments of the Link Mapping Table for Digital Audio Broadcasting Service Grouping indicate one or more groupings of a plurality of Digital Audio Broadcasting services of the ATSC transmission,
wherein the output interface is configured to provide, depending on at least one of the one or more groupings, an output that depends on at least one of the plurality of Digital Audio Broadcasting Digital Audio Broadcasting services.

30. An apparatus according to claim 26,
wherein the one or more still further ATSC Link-layer Protocol packets are two or more still further ATSC Link-layer Protocol packets, wherein the one or more fragments of the Link Mapping Table for Service Grouping are two or more fragments,
wherein the two or more still further ATSC Link-layer Protocol packets comprise the two or more fragments of the Link Mapping Table for Service Grouping.

31. An apparatus according to claim 26,
wherein the apparatus is configured to employ the Link Mapping Table for Service Grouping to allow a user to select a service from the plurality of services.

32. An apparatus according to claim 26,
wherein the apparatus is configured to employ the Link Mapping Table for Service Grouping to present a user a filtered subset of the plurality of services depending on one or more filter criteria.

33. An apparatus according to claim 26,
wherein the output interface is configured to output information on at least two of the plurality of services depending on at least one of the one or more groupings, and
wherein the apparatus comprises a user interface or another mechanism for allowing a user to select a service from the information on the at least two of the plurality of services.

34. An apparatus according to claim 26,
wherein the one or more fragments of the Link Mapping Table for Service Grouping associate two or more of the plurality of services with at least one of two or more categories, and/or with at least one of two or more properties.

35. An apparatus according to claim 33,
wherein the one or more fragments of the Link Mapping Table for Service Grouping associate two or more of the plurality of services with at least one of two or more categories, and/or with at least one of two or more properties
wherein, if a user has selected, using the user interface or the other mechanism, at least two categories from the two or more categories, the output interface is configured to present only those of the plurality of services to the user which are associated with all of the at least two categories which the user has selected.

36. An apparatus according to claim 33,
wherein the one or more fragments of the Link Mapping Table for Service Grouping associate two or more of the plurality of services with at least one of two or more categories, and/or with at least one of two or more properties
wherein, if a user has selected, using the user interface or the other mechanism, at least two categories from the two or more categories, the output interface is configured to present only those of the plurality of services to the user which are associated with all of the at least two categories which the user has selected,
wherein, if a user has selected, using the user interface or the other mechanism, at least two properties from the two or more properties, the output interface is configured to present those of the plurality of services to the user which are associated with at least one of the at least two properties which the user has selected.

37. An apparatus according to claim 26,
wherein the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

38. An apparatus according to claim 11,
an interface for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
a decoding unit, wherein the decoding unit is configured to decode the packet payload of each one of at least one ATSC Link-layer Protocol packet of the plurality of ATSC Link-layer Protocol packets to acquire the digital content of said one of the at least one ATSC Link-layer Protocol packet,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein the apparatus comprises an output interface for providing, depending on at least one of the one or more groupings, an output that depends on at least one of the plurality of services,
wherein the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

39. An apparatus according to claim 1,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

40. An apparatus for decoding, comprising:
an interface for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
a decoding unit, wherein the decoding unit is configured to decode the packet payload of each one of at least one ATSC Link-layer Protocol packet of the plurality of ATSC Link-layer Protocol packets to acquire the digital content of said one of the at least one ATSC Link-layer Protocol packet,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

41. An apparatus according to claim 40,
wherein at least one table of the one or more tables comprises two or more table fragments,
wherein information on at least one of the one or more management parameters is present in each of the two or more table fragments.

42. An apparatus according to claim 41,
wherein the one or more management parameters comprise a plurality of management parameters,
wherein information on each of the plurality of management parameters is present in each of the two or more table fragments.

43. An apparatus according to claim 40,
wherein at least one table fragment of the one or more table fragments of a table of the one or more tables comprises, as the information on one of the one or more management parameters, a value for a data revision parameter for said table,
wherein the decoding unit is configured to compare a current revision number for said table stored at the decoding unit and the value for said data revision parameter for said table of the at least one table fragment to determine whether or not updating stored information for said table stored at the decoding unit is needed.

44. An apparatus according to claim 43,
wherein each one of at least one table fragment of the one or more table fragments of a table of the one or more tables comprises, as the information on another one of the one or more management parameters, a value for a fragment data revision parameter for said one of the at least one table fragment,
wherein the decoding unit is configured to compare a current revision number for said table fragment stored at the decoding unit and the value for said fragment data revision parameter for said table fragment to determine whether or not updating stored information for said table fragment stored at the decoding unit is needed.

45. An apparatus according to claim 40,
wherein a body section of at least one of the one or more table fragments of at least one table the of one or more tables is compressed.

46. An apparatus according to claim 45,
wherein each table fragment of the one or more table fragments of said at least one table comprises, as the information on a further one of the one or more management parameters, a compression value indicating whether or not the body section of said table fragment is compressed.

47. An apparatus according to claim 44,
wherein a body section of at least one of the one or more table fragments of at least one table the of one or more tables is compressed,
wherein each table fragment of the one or more table fragments of said at least one table comprises, as the information on a further one of the one or more management parameters, a compression value indicating whether or not the body section of said table fragment is compressed,
wherein the decoding unit is configured to decompress the body section of a table fragment of said at least one of the one or more table fragments, if the decoding unit has determined that updating the stored information for said table fragment stored at the decoding unit is needed, and
wherein the decoding unit is configured to not decompress the body section of said table fragment, if the decoding unit has determined that updating the stored information for said table fragment stored at the decoding unit is not necessary.

48. An apparatus according to claim 40,
wherein each one of at least one table fragment of the one or more table fragments of a table of the one or more tables comprises revision table information for said table,
wherein the revision table information for said table indicates a value for a fragment data revision parameter of each table fragment of the one or more table fragments of said table in the ATSC transmission.

49. An apparatus according to claim 48,
wherein the decoding unit is configured to compare a current revision number for said table fragment stored at the decoding unit and the value for said fragment data revision parameter for said table fragment to determine whether or not updating stored information for said table fragment stored at the decoding unit is needed.

50. An apparatus according to claim 48,
wherein the revision table information for said table indicates a location of each of the one or more table fragments of said table in the ATSC transmission.

51. An apparatus according to claim 50,
wherein the revision table information for said table indicates the location of each table fragment of the one or more table fragments of said table in the ATSC transmission by indicating a physical layer pipe and/or by indicating an ATSC Link-layer Protocol packet, which comprise said table fragment.

52. An apparatus according to claim 50,
wherein each one of at least one table fragment of the one or more table fragments of a table of the one or more tables comprises revision table information for said table,
wherein the revision table information for said table indicates a value for a fragment data revision parameter of each table fragment of the one or more table fragments of said table in the ATSC transmission,
wherein the decoding unit is configured to compare a current revision number for said table fragment stored at the decoding unit and the value for said fragment data revision parameter for said table fragment to determine whether or not updating stored information for said table fragment stored at the decoding unit is needed,
wherein the decoding unit is configured to acquire said table fragment from its location in the ATSC transmission, if the decoding unit has determined that updating the stored information for said table fragment stored at the decoding unit is needed, and
wherein the decoding unit is configured to not acquire said table fragment from its location in the ATSC transmission, if the decoding unit has determined that updating the stored information for said table fragment stored at the decoding unit is not necessary.

53. An apparatus according to claim 11,
an interface for receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
a decoding unit, wherein the decoding unit is configured to decode the packet payload of each one of at least one ATSC Link-layer Protocol packet of the plurality of ATSC Link-layer Protocol packets to acquire the digital content of said one of the at least one ATSC Link-layer Protocol packet,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters,
wherein the one or more table fragments of each of one or more tables comprise the one or more fragments of the Link Mapping Table for services.

54. An apparatus according to claim 11,
wherein each table fragment of the one or more table fragments of said at least one table comprises, as the information on a further one of the one or more management parameters, a compression value indicating whether or not the body section of said table fragment is compressed,
wherein the one or more table fragments of each of one or more tables comprise the one or more fragments of the Link Mapping Table for Service Grouping.

55. An apparatus according to 40,
wherein one or more table fragments of each of one or more tables comprise one or more fragments of a Logo/Icon Table comprising information on one or more versions of a logo or icon, and/or
wherein one or more table fragments of each of one or more tables comprise one or more fragments of a Logo/Icon Variant comprising image data of a version of a logo or icon.

56. An apparatus according to claim 40,
wherein a first table of the one or more tables exhibits a first table type, wherein a second table of one or more tables exhibits a second table type being different from the first table type,
wherein the decoding unit is configured to decode the one or more table fragments of the first table and the one or more table fragments of the second table using a same decoding algorithm.

57. An apparatus according to claim 56,
wherein the first table exhibits one of a group of at least four table types, which comprise the table types:
Link Mapping Table for radio services (LMT-R),
Link Mapping Table for Service Grouping (LMT-R-SG),
Logo/Icon Table (LIT),
Logo/Icon Variant (LIV),
wherein the second table exhibits a different one of the group of the at least four table types.

58. An apparatus for generating a plurality of ATSC Link-layer Protocol packets, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content,
wherein the packet generator is configured to generate one or more ATSC Link-layer Protocol packets of the plurality of ATSC Link-layer Protocol packets, such that the digital content being encapsulated within the packet payload of each of the one or more ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

59. An apparatus according to claim 58,
wherein the packet generator is configured to generate an ATSC Link-layer Protocol packet of the one or more ATSC Link-layer Protocol packets, such that the digital content being encapsulated within said ATSC Link-layer Protocol packet comprises digital radio content.

60. An apparatus according to claim 58,
wherein the packet generator is configured to generate an ATSC Link-layer Protocol packet of the one or more ATSC Link-layer Protocol packets, such that the digital content being encapsulated within said ATSC Link-layer Protocol packet comprises a Distribution and Communications Protocol packet or a portion thereof.

61. An apparatus according to claim 60,
wherein the Distribution and Communications Protocol packet or the portion thereof being encapsulated within the packet payload of said ATSC Link-layer Protocol packet comprises digital radio content.

62. An apparatus according to claim 59,
wherein the digital radio content comprises Digital Radio Mondial content.

63. An apparatus according to claim 58,
wherein the packet generator is configured to generate an ATSC Link-layer Protocol packet of the one or more ATSC Link-layer Protocol packets, such that the digital content being encapsulated within said ATSC Link-layer Protocol packet comprises Unified Speech and Audio Coding content or extended High Efficiency Advanced Audio Coding content.

64. An apparatus according to claim 58,
wherein the packet generator is configured to generate an ATSC Link-layer Protocol packet of the one or more ATSC Link-layer Protocol packets, such that the digital content being encapsulated within said ATSC Link-layer Protocol packet comprises Journaline content.

65. An apparatus according to claim 58,
wherein the packet generator is configured to generate the plurality of ATSC Link-layer Protocol packets, such that one or more further ATSC Link-layer Protocol packets of the plurality of ATSC Link-layer Protocol packets comprise one or more fragments of a Link Mapping Table for services,
wherein the one or more fragments of the Link Mapping Table for services indicate one or more services of an ATSC transmission.

66. An apparatus for generating a plurality of ATSC Link-layer Protocol packets, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more further ATSC Link-layer Protocol packets of the plurality of ATSC Link-layer Protocol packets comprise one or more fragments of a Link Mapping Table for services, wherein the one or more fragments of the Link Mapping Table for services indicate the one or more services of the ATSC transmission.

67. An apparatus according to claim 66,
wherein the one or more fragments of the Link Mapping Table for services are one or more fragments of a Link Mapping Table for radio services,
wherein the one or more fragments of the Link Mapping Table for radio services indicate one or more radio services of the ATSC transmission.

68. An apparatus according to claim 67,
wherein the packet generator is configured to generate the one or more further ATSC Link-layer Protocol packets, such that the one or more fragments of the Link Mapping Table for radio services comprise metadata for the one or more radio services of the ATSC transmission.

69. An apparatus according to claim 68,
wherein at least some of the plurality of ATSC Link-layer Protocol packets encapsulate a plurality of Distribution and Communications Protocol packets comprising the one or more radio services of the ATSC transmission.

70. An apparatus according to claim 68,
wherein the packet generator is configured to generate the one or more further ATSC Link-layer Protocol packets, such that the metadata for the one or more radio services comprises information on a service label, and/or information on a multiplex label, and/or information on a language, and/or information on a program type, and/or information on a region, and/or information on a country of origin, and/or audio configuration information, and/or a data application identifier.

71. An apparatus according to claim 67,
wherein the packet generator is configured to generate the one or more further ATSC Link-layer Protocol packets, such that the one or more fragments of the Link Mapping Table for radio services are one or more fragments of the Link Mapping Table for Digital Radio Mondiale-Radio, wherein the one or more fragments of the Link Mapping Table for Digital Radio Mondiale-Radio indicate one or more Digital Radio Mondiale radio services of the ATSC transmission.

72. An apparatus according to claim 71,
wherein the packet generator is configured to generate the one or more further ATSC Link-layer Protocol packets, such that the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams.

73. An apparatus according to claim 72,
wherein the packet generator is configured to generate the one or more further ATSC Link-layer Protocol packets, such that the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

74. An apparatus according to claim 68,
wherein the packet generator is configured to generate the one or more further ATSC Link-layer Protocol packets, such that the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams,
wherein the packet generator is configured to generate the one or more further ATSC Link-layer Protocol packets, such that the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams,
wherein the packet generator is configured to analyse one or more Digital Radio Mondiale Multiplex Distribution Interface streams, which are associated with the one or more Digital Radio Mondiale radio services, and
wherein the packet generator is configured to generate the one or more further ATSC Link-layer Protocol packets, such that the metadata for one of the one or more Digital Radio Mondiale radio services corresponds to metadata being comprised by one of the one or more Digital Radio Mondiale Multiplex Distribution Interface streams, which are associated with the one or more Digital Radio Mondiale radio services.

75. An apparatus according to claim 72,
wherein the packet generator is configured to analyse one or more Digital Radio Mondiale Multiplex Distribution Interface streams, which are associated with the one or more Digital Radio Mondiale radio services, and
wherein the packet generator is configured to generate the one or more further ATSC Link-layer Protocol packets, such that the one or more fragments of the Link Mapping Table for radio services comprise emergency warning information indicating whether or not an emergency warning is indicated by at least one of the one or more Digital Radio Mondiale Multiplex Distribution Interface streams, which are associated with the one or more Digital Radio Mondiale radio services.

76. An apparatus according to claim 72,
wherein the packet generator is configured to generate the plurality of ATSC Link-layer Protocol packets, such that, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets comprises a same sub-stream identifier being associated with the Digital Radio Mondiale Multiplex Distribution Interface stream.

77. An apparatus according to claim 66,
wherein the one or more fragments of the Link Mapping Table for radio services are one or more fragments of the Link Mapping Table for Digital Audio Broadcasting,
wherein the one or more fragments of the Link Mapping Table for Digital Audio Broadcasting indicate one or more Digital Audio Broadcasting services of the ATSC transmission.

78. An apparatus according to claim 77,
wherein the one or more fragments of the Link Mapping Table for Digital Audio Broadcasting indicate an association of at least one of the one or more Digital Audio Broadcasting services with one or more EDI (Encapsulation of DAB Interfaces) streams.

79. An apparatus according to claim 66,
wherein the one or more further ATSC Link-layer Protocol packets are two or more further ATSC Link-layer Protocol packets, wherein the one or more fragments are two or more fragments, wherein the one or more services are a plurality of services,
wherein the packet generator is configured to generate the two or more further ATSC Link-layer Protocol packets, such that the two or more further ATSC Link-layer Protocol packets comprise the two or more fragments of the Link Mapping Table for services, wherein the two or more fragments of the Link Mapping Table for services indicate the plurality of services of the ATSC transmission.

80. An apparatus according to claim 66,
wherein the apparatus is configured to repeatedly transmit the one or more ATSC Link-layer Protocol packets which comprise the one or more fragments of the Link Mapping Table for services.

81. An apparatus according to claim 58 or 66,
wherein the packet generator is configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

82. An apparatus for generating a plurality of ATSC Link-layer Protocol packets, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

83. An apparatus according to claim 82,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission.

84. An apparatus according to claim 83,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission.

85. An apparatus according to claim 83,
wherein the one or more fragments of the Link Mapping Table for Service Grouping are one or more fragments of a Link Mapping Table for Digital Audio Broadcasting Service Grouping,
wherein the one or more fragments of the Link Mapping Table for Digital Audio Broadcasting Service Grouping indicate one or more groupings of a plurality of Digital Audio Broadcasting services of the ATSC transmission.

86. An apparatus according to claim 82,
wherein the one or more still further ATSC Link-layer Protocol packets are two or more still further ATSC Link-layer Protocol packets, wherein the one or more fragments of the Link Mapping Table for Service Grouping are two or more fragments,
wherein the packet generator is configured to generate the two or more still further ATSC Link-layer Protocol packets, such that the two or more still further ATSC Link-layer Protocol packets comprise the two or more fragments of the Link Mapping Table for Service Grouping.

87. An apparatus according to claim 82,
wherein the packet generator is configured to generate the one or more still further ATSC Link-layer Protocol packets, such that the one or more fragments of the Link Mapping Table for Service Grouping associate two or more of the plurality of services with at least one of two or more categories, and/or with at least one of two or more properties.

88. An apparatus according to 82,
wherein the packet generator is configured to generate the one or more still further ATSC Link-layer Protocol packets, such that the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

89. An apparatus according to claim 66, wherein the apparatus comprises
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein the packet generator is configured to generate the one or more still further ATSC Link-layer Protocol packets, such that the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

90. An apparatus according to claim 82,
wherein the apparatus is configured to repeatedly transmit the one or more still further ATSC Link-layer Protocol packets which comprise the one or more fragments of the Link Mapping Table for Service Grouping.

91. An apparatus according to claim 58,
wherein the packet generator is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

92. An apparatus for generating a plurality of ATSC Link-layer Protocol packets, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

93. An apparatus according to claim 92,
wherein at least one table of the one or more tables comprises two or more table fragments,
wherein information on at least one of the one or more management parameters is present in each of the two or more table fragments.

94. An apparatus according to claim 93,
wherein the one or more management parameters comprise a plurality of management parameters,
wherein information on each of the plurality of management parameters is present in each of the two or more table fragments.

95. An apparatus according to claim 92,
wherein at least one table fragment of the one or more table fragments of a table of the one or more tables comprises, as the information on one of the one or more management parameters, a value for a data revision parameter for said table.

96. An apparatus according to claim 95,
wherein each one of at least one table fragment of the one or more table fragments of a table of the one or more tables comprises, as the information on another one of the one or more management parameters, a value for a fragment data revision parameter for said one of the at least one table fragment.

97. An apparatus according to claim 92,
wherein the packet generator is configured to generate the plurality of ATSC Link-layer Protocol packets, such that a body section of at least one of the one or more table fragments of at least one table the of one or more tables is compressed.

98. An apparatus according to claim 97,
wherein each table fragment of the one or more table fragments of said at least one table comprises, as the information on a further one of the one or more management parameters, a compression value indicating whether or not the body section of said table fragment is compressed.

99. An apparatus according to claim 92,
wherein the packet generator is configured to generate the plurality of ATSC Link-layer Protocol packets, such that each one of at least one table fragment of the one or more table fragments of a table of the one or more tables comprises revision table information for said table,
wherein the revision table information for said table indicates a value for a fragment data revision parameter of each table fragment of the one or more table fragments of said table in the ATSC transmission.

100. An apparatus according to claim 99,
wherein the revision table information for said table indicates a location of each of the one or more table fragments of said table in the ATSC transmission.

101. An apparatus according to claim 100,
wherein the revision table information for said table indicates the location of each table fragment of the one or more table fragments of said table in the ATSC transmission by indicating a physical layer pipe and/or by indicating an ATSC Link-layer Protocol packet, which comprise said table fragment.

102. An apparatus according to claim 66, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters,
wherein the one or more table fragments of each of one or more tables comprise the one or more fragments of the Link Mapping Table for services.

103. An apparatus according to claim 82, wherein the apparatus comprises:
an interface for receiving input data, and
a packet generator for generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the packet generator is configured to generate the plurality of ATSC Link-layer Protocol packets, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters,
wherein the one or more table fragments of each of one or more tables comprise the one or more fragments of the Link Mapping Table for Service Grouping.

104. An apparatus according to claim 92,
wherein one or more table fragments of each of one or more tables comprise one or more fragments of a Logo/Icon Table comprising information on one or more versions of a logo or icon, and/or
wherein one or more table fragments of each of one or more tables comprise one or more fragments of a Logo/Icon Variant comprising image data of a version of a logo or icon.

105. An apparatus according to claim 92,
wherein a first table of the one or more tables exhibits a first table type, wherein a second table of one or more tables exhibits a second table type being different from the first table type.

106. An apparatus according to claim 105,
wherein the first table exhibits one of a group of at least four table types, which comprise the table types:
Link Mapping Table for radio services (LMT-R),
Link Mapping Table for Service Grouping (LMT-R-SG),
Logo/Icon Table (LIT),
Logo/Icon Variant (LIV),
wherein the second table exhibits a different one of the group of the at least four table types.

107. A data stream comprising a plurality of ATSC Link-layer Protocol packets,
wherein each of the plurality of ATSC Link-layer Protocol packets comprises a packet header and a packet payload encapsulating digital content,
wherein the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

108. A data stream according to claim 107,
wherein the digital content being encapsulated within said ATSC Link-layer Protocol packet comprises digital radio content.

109. A data stream according to claim 107,
wherein the digital content being encapsulated within said ATSC Link-layer Protocol packet comprises a Distribution and Communications Protocol packet or a portion thereof.

110. A data stream according to claim 109,
wherein the Distribution and Communications Protocol packet or the portion thereof being encapsulated within the packet payload of said ATSC Link-layer Protocol packet comprises digital radio content.

111. A data stream according to claim 108,
wherein the digital radio content comprises Digital Radio Mondial content.

112. A data stream according to claim 107,
wherein the digital content being encapsulated within said ATSC Link-layer Protocol packet comprises Unified Speech and Audio Coding content or extended High Efficiency Advanced Audio Coding content.

113. A data stream according to claim 107,
wherein the digital content being encapsulated within said ATSC Link-layer Protocol packet comprises Journaline content.

114. A data stream according to claim 107,
wherein the data stream comprises one or more further ATSC Link-layer Protocol packets of the plurality of ATSC Link-layer Protocol packets, which comprise one or more fragments of a Link Mapping Table for services,
wherein the one or more fragments of the Link Mapping Table for services indicate one or more services of an ATSC transmission.

115. A data stream comprising a plurality of ATSC Link-layer Protocol packets,
wherein each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the data stream comprises one or more ATSC Link-layer Protocol packets of the plurality of ATSC Link-layer Protocol packets, which comprise one or more fragments of a Link Mapping Table for services,
wherein the one or more fragments of the Link Mapping Table for services indicate the one or more services of the ATSC transmission.

116. A data stream according to claim 115,
wherein the one or more fragments of the Link Mapping Table for services are one or more fragments of a Link Mapping Table for radio services,
wherein the one or more fragments of the Link Mapping Table for radio services indicate one or more radio services of the ATSC transmission.

117. A data stream according to claim 116,
wherein the one or more fragments of the Link Mapping Table for radio services comprise metadata for the one or more radio services of the ATSC transmission.

118. A data stream according to claim 117,
wherein at least some of the plurality of ATSC Link-layer Protocol packets encapsulate a plurality of Distribution and Communications Protocol packets comprising the one or more radio services of the ATSC transmission.

119. A data stream according to claim 117,
wherein the metadata for the one or more radio services comprises information on a service label, and/or information on a multiplex label, and/or information on a language, and/or information on a program type, and/or information on a region, and/or information on a country of origin, and/or audio configuration information, and/or a data application identifier.

120. A data stream according to claim 116,
wherein the one or more fragments of the Link Mapping Table for radio services are one or more fragments of the Link Mapping Table for Digital Radio Mondiale-Radio, wherein the one or more fragments of the Link Mapping Table for Digital Radio Mondiale-Radio indicate one or more Digital Radio Mondiale radio services of the ATSC transmission.

121. A data stream according to claim 120,
wherein the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams.

122. A data stream according to claim 121,
wherein the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams.

123. A data stream according to claim 117,
wherein the one or more fragments of the Link Mapping Table for Digital Radio Mondiale-Radio indicate an association of at least one of the one or more Digital Radio Mondiale radio services with one or more Digital Radio Mondiale Multiplex Distribution Interface streams,
wherein the one or more fragments of the Link Mapping Table for Digital Radio Mondiale-Radio indicate the association of at least one of the one or more Digital Radio Mondiale radio services with the one or more Digital Radio Mondiale Multiplex Distribution Interface streams by indicating a Physical Layer Pipe identifier and/or an ATSC Link-layer Protocol packet identifier, and by indicating at least one of the one or more Digital Radio Mondiale radio service identifiers that is associated with said one of the one or more Digital Radio Mondiale Multiplex Distribution Interface streams,
wherein the metadata for one of the one or more Digital Radio Mondiale radio services corresponds to metadata being comprised by one of one or more Digital Radio Mondiale Multiplex Distribution Interface streams, which are associated with the one or more Digital Radio Mondiale radio services.

124. A data stream according to claim 121,
wherein the one or more fragments of the Link Mapping Table for radio services comprise emergency warning information indicating whether or not an emergency warning is indicated by at least one of one or more Digital Radio Mondiale Multiplex Distribution Interface streams, which are associated with the one or more Digital Radio Mondiale radio services.

125. A data stream according to claim 121,
wherein, if the packet payload of two ATSC Link-layer Protocol packets of the plurality of ATSC Link-layer Protocol packets comprise Digital Radio Mondiale content of a same Digital Radio Mondiale Multiplex Distribution Interface stream, the packet header of the two ATSC Link-layer Protocol packets comprises a same sub-stream identifier being associated with the Digital Radio Mondiale Multiplex Distribution Interface stream.

126. A data stream according to claim 115,
wherein the one or more fragments of the Link Mapping Table for radio services are one or more fragments of the Link Mapping Table for Digital Audio Broadcasting,
wherein the one or more fragments of the Link Mapping Table for Digital Audio Broadcasting indicate one or more Digital Audio Broadcasting services of the ATSC transmission.

127. A data stream according to claim 126,
wherein the one or more fragments of the Link Mapping Table for Digital Audio Broadcasting indicate an association of at least one of the one or more Digital Audio Broadcasting services with one or more EDI (Encapsulation of DAB Interfaces) streams.

128. A data stream according to claim 115,
wherein the one or more further ATSC Link-layer Protocol packets are two or more further ATSC Link-layer Protocol packets, wherein the one or more fragments are two or more fragments, wherein the one or more services are a plurality of services,
wherein the two or more further ATSC Link-layer Protocol packets comprise the two or more fragments of the Link Mapping Table for services, wherein the two or more fragments of the Link Mapping Table for services indicate the plurality of services of the ATSC transmission.

129. A data stream according to claim 107 or 115,
wherein the data stream comprises one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission.

130. A data stream comprising a plurality of ATSC Link-layer Protocol packets,
wherein each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the data stream comprises one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission.

131. A data stream according to claim 130,
wherein the one or more fragments of the Link Mapping Table for Service Grouping are one or more fragments of a Link Mapping Table for Radio Service Grouping,
wherein the one or more fragments of the Link Mapping Table for Radio Service Grouping indicate one or more groupings of a plurality of radio services of the ATSC transmission.

132. A data stream according to claim 131,
wherein the one or more fragments of the Link Mapping Table for Service Grouping are one or more fragments of a Link Mapping Table for Digital Radio Mondiale-Radio Service Grouping,
wherein the one or more fragments of the Link Mapping Table for Digital Radio Mondiale-Radio Service Grouping indicate one or more groupings of a plurality of Digital Radio Mondiale radio services of the ATSC transmission.

133. An data stream according to claim 131,
wherein the one or more fragments of the Link Mapping Table for Service Grouping are one or more fragments of a Link Mapping Table for Digital Audio Broadcasting Service Grouping,
wherein the one or more fragments of the Link Mapping Table for Digital Audio Broadcasting Service Grouping indicate one or more groupings of a plurality of Digital Audio Broadcasting services of the ATSC transmission.

134. A data stream according to claim 130,
wherein the one or more still further ATSC Link-layer Protocol packets are two or more still further ATSC Link-layer Protocol packets, wherein the one or more fragments of the Link Mapping Table for Service Grouping are two or more fragments,
wherein the two or more still further ATSC Link-layer Protocol packets comprise the two or more fragments of the Link Mapping Table for Service Grouping.

135. A data stream according to claim 130,
wherein the one or more fragments of the Link Mapping Table for Service Grouping associate two or more of the plurality of services with at least one of two or more categories, and/or with at least one of two or more properties.

136. A data stream according to claim 130,
wherein the one or more fragments of the Link Mapping Table for Service Grouping indicate the one or more groupings comprising a grouping that depends on language, and/or comprising a grouping that depends on a program type, and/or comprising a grouping that depends on a region, and/or comprising a grouping that depends on a country of origin, and/or comprising a grouping that depends on a target audience age group, and/or comprising a grouping that depends on a broadcast network; and/or comprising a grouping that depends on a data application type.

137. A data stream according to claim 115,
packet header and a packet payload encapsulating digital content, wherein one or more of the plurality of ATSC Link-layer Protocol packets comprises content of one or more services of an ATSC transmission,
wherein the data stream comprises one or more still further ATSC Link-layer Protocol packets of the plurality of ATSC Link-layer Protocol packets, which comprise one or more fragments of a Link Mapping Table for Service Grouping, which indicate one or more groupings of a plurality of services of an ATSC transmission,
wherein the one or more fragments of the Link Mapping Table for services comprise an indication that indicates a Physical Layer Pipe and/or an indication that indicates an ATSC Link-layer Protocol packet, which comprise one of the one or more fragments of the Link Mapping Table for Service Grouping.

138. A data stream according to claim 107 or 115 or 130,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

139. A data stream comprising a plurality of ATSC Link-layer Protocol packets,
wherein each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

140. A data stream according to claim 139,
wherein at least one table of the one or more tables comprises two or more table fragments,
wherein information on at least one of the one or more management parameters is present in each of the two or more table fragments.

141. A data stream according to claim 140,
wherein the one or more management parameters comprise a plurality of management parameters,
wherein information on each of the plurality of management parameters is present in each of the two or more table fragments.

142. A data stream according to claim 139,
wherein at least one table fragment of the one or more table fragments of a table of the one or more tables comprises, as the information on one of the one or more management parameters, a value for a data revision parameter for said table.

143. A data stream according to claim 142,
wherein each one of at least one table fragment of the one or more table fragments of a table of the one or more tables comprises, as the information on another one of the one or more management parameters, a value for a fragment data revision parameter for said one of the at least one table fragment.

144. A data stream according to claim 139,
wherein a body section of at least one of the one or more table fragments of at least one table the of one or more tables is compressed.

145. A data stream according to claim 144,
wherein each table fragment of the one or more table fragments of said at least one table comprises, as the information on a further one of the one or more management parameters, a compression value indicating whether or not the body section of said table fragment is compressed.

146. A data stream according to claim 139,
wherein each one of at least one table fragment of the one or more table fragments of a table of the one or more tables comprises revision table information for said table,
wherein the revision table information for said table indicates a value for a fragment data revision parameter of each table fragment of the one or more table fragments of said table in the ATSC transmission.

147. A data stream according to claim 146,
wherein the revision table information for said table indicates a location of each of the one or more table fragments of said table in the ATSC transmission.

148. A data stream according to claim 147,
wherein the revision table information for said table indicates the location of each table fragment of the one or more table fragments of said table in the ATSC transmission by indicating a physical layer pipe and/or by indicating an ATSC Link-layer Protocol packet, which comprise said table fragment.

149. A data stream according to claim 115,
wherein each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters,
wherein the one or more table fragments of each of one or more tables comprise the one or more fragments of the Link Mapping Table for services.

150. A data stream according to claim 130,
wherein each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters,
wherein the one or more table fragments of each of one or more tables comprise the one or more fragments of the Link Mapping Table for Service Grouping.

151. A data stream according to claim 139,
wherein one or more table fragments of each of one or more tables comprise one or more fragments of a Logo/Icon Table comprising information on one or more versions of a logo or icon, and/or
wherein one or more table fragments of each of one or more tables comprise one or more fragments of a Logo/Icon Variant comprising image data of a version of a logo or icon.

152. A data stream according to claim 139,
wherein a first table of the one or more tables exhibits a first table type, wherein a second table of one or more tables exhibits a second table type being different from the first table type.

153. A data stream according to claim 152,
wherein the first table exhibits one of a group of at least four table types, which comprise the table types:
Link Mapping Table for radio services (LMT-R),
Link Mapping Table for Service Grouping (LMT-R-SG),
Logo/Icon Table (LIT),
Logo/Icon Variant (LIV),
wherein the second table exhibits a different one of the group of the at least four table types.

154. A system, comprising:
an apparatus according to claim 58 or 66 or 82 or 92 for generating a plurality of ATSC Link-layer Protocol packets, and
an apparatus according to claim 1 or 11 or 26 or 40 for decoding, wherein the apparatus for decoding is configured to receive and decode the plurality of ATSC Link-layer Protocol packets.

155. A method for decoding, comprising:
receiving a plurality of ATSC Link-layer Protocol packets each of which comprising a packet header and a packet payload encapsulating digital content, wherein the digital content being encapsulated within the packet payload of each of one or more ATSC Link-layer Protocol packets of the plurality of ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content, and
decoding the packet payload of each one of at least one ATSC Link-layer Protocol packet of the one or more ATSC Link-layer Protocol packets to acquire the digital content of said one of the at least one ATSC Link-layer Protocol packet.

156. A method for decoding, comprising:
receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
decoding the packet payload of each one of at least one ATSC Link-layer Protocol packet of the plurality of ATSC Link-layer Protocol packets to acquire the digital content of said one of the at least one ATSC Link-layer Protocol packet,
wherein one or more further ATSC Link-layer Protocol packets of the plurality of ATSC Link-layer Protocol packets comprise one or more fragments of a Link Mapping Table for services,
wherein the one or more fragments of the Link Mapping Table for services indicate the one or more services of the ATSC transmission,
wherein the method comprises identifying the ATSC Link-layer Protocol packet which comprises content of one of the one or more services by analyzing the one or more fragments of the Link Mapping Table for services.

157. A method for decoding, comprising:
receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
decoding the packet payload of each one of at least one ATSC Link-layer Protocol packet of the plurality of ATSC Link-layer Protocol packets to acquire the digital content of said one of the at least one ATSC Link-layer Protocol packet,
wherein one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission,
wherein the method comprises providing, depending on at least one of the one or more groupings, an output that depends on at least one of the plurality of services.

158. A method for decoding, comprising:
receiving a plurality of ATSC Link-layer Protocol packets each of which comprising a packet header and a packet payload encapsulating digital content, wherein one or more of the plurality of ATSC Link-layer Protocol packets comprises content of one or more services of an ATSC transmission, and
decoding the packet payload of each one of at least one ATSC Link-layer Protocol packet of the plurality of ATSC Link-layer Protocol packets to acquire the digital content of said one of the at least one ATSC Link-layer Protocol packet,
wherein one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

159. A method for generating a plurality of ATSC Link-layer Protocol packets, wherein the method comprises:
receiving input data, and
generating the plurality of ATSC Link-layer Protocol packets depending on the input data, such that each of the plurality of ATSC Link-layer Protocol packets comprises a packet header and a packet payload encapsulating digital content,
wherein generating one or more ATSC Link-layer Protocol packets of the plurality of ATSC Link-layer Protocol packets is conducted, such that the digital content being encapsulated within the packet payload of each of the one or more ATSC Link-layer Protocol packets comprises digital radio content, and/or a Distribution and Communications Protocol packet or a portion thereof, and/or Unified Speech and Audio Coding content or extended High Efficiency Advanced Audio Coding content, and/or Journaline content.

160. A method for generating a plurality of ATSC Link-layer Protocol packets, wherein the method comprises:
receiving input data, and
generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein the method comprises generating the plurality of ATSC Link-layer Protocol packets, such that one or more further ATSC Link-layer Protocol packets of the plurality of ATSC Link-layer Protocol packets comprise one or more fragments of a Link Mapping Table for services, wherein the one or more fragments of the Link Mapping Table for services indicate the one or more services of the ATSC transmission.

161. A method for generating a plurality of ATSC Link-layer Protocol packets, wherein the method comprises:
receiving input data, and
generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein generating the plurality of ATSC Link-layer Protocol packets is conducted, such that one or more still further ATSC Link-layer Protocol packets of the plurality of ATSC Link-layer Protocol packets comprise one or more fragments of a Link Mapping Table for Service Grouping, which indicate one or more groupings of a plurality of services of an ATSC transmission.

162. A method for generating a plurality of ATSC Link-layer Protocol packets, wherein the apparatus comprises:
receiving input data, and
generating the plurality of ATSC Link-layer Protocol packets depending on the input data, such that each of the plurality of ATSC Link-layer Protocol packets comprises a packet header and a packet payload encapsulating digital content, wherein one or more of the plurality of ATSC Link-layer Protocol packets comprises content of one or more services of an ATSC transmission,
wherein generating the plurality of ATSC Link-layer Protocol packets is conducted, such that one or more other ATSC Link-layer Protocol packets of the plurality of ATSC Link-layer Protocol packets comprise one or more table fragments of each of one or more tables, wherein each of the one or more table fragments comprises metadata supporting a selection of a service, and/or comprises information on a content of the payload of each of one or more of the plurality of ATSC Link-layer Protocol packets, and/or comprises information on another one of the one or more table fragments,
wherein each table fragment of the one or more table fragments of each table of one or more tables comprises table management information which comprises management information for said table fragment and/or for said table, wherein the table management information comprises information on one or more management parameters.

163. A non-transitory digital storage medium having a computer program stored thereon to perform the method of claim 155 or 156 or 157 or 158 or 159 or 160 or 161 or 162 when said computer program is run by a computer.
